(19) United States
(12) Patent Application Publication
(10) Pub. No.: US 2012/0053885 A1
(43) Pub. Date: Mar. 1, 2012

(54) INFORMATION PROCESSING APPARATUS AND METHOD FOR ENVIRONMENTAL ANALYSIS

(75) Inventor: Kazunori Kato, Yokohama-shi (JP)

(73) Assignee: CANON KABUSHIKI KAISHA, Tokyo (JP)

(21) Appl. No.: 13/218,785

(22) Filed: Aug. 26, 2011

(30) Foreign Application Priority Data
Aug. 31, 2010 (JP) 2010-193849

(51) Int. Cl. G06F 15/00

(52) U.S. Cl. 702/128

(57) ABSTRACT

An information processing apparatus counts as a result the number of sheets output by an image forming apparatus with reference to collected job history information and obtains the amount of electric power consumed by the image forming apparatus based on the job history information. When the information processing apparatus generates display data required to display a screen indicating an emission amount of greenhouse effect gases, the information processing apparatus analyzes the number of sheets that is output if a saving setting is applied to a job corresponding to a history included in the job history information. The information processing apparatus generates the display data required to display the screen in such a way as to indicate an emission amount of the greenhouse effect gas obtained based on the analyzed number of sheets.

### BACKGROUND OF THE INVENTION

1. Field of the Invention

Embodiments of the present invention relate to a technique for estimating the burden placed on the environments when an image forming apparatus is used.

2. Description of the Related Art

As one of recent trends, reducing the consumption of electric power and the amount of sheets in an operation of a printer, a copying machine, a multifunction peripheral, or any other image forming apparatus (hereinafter, collectively referred to as “device”) is required to reduce an emission amount of greenhouse effect gases, such as carbon dioxide (CO2). Therefore, it is desired to visualize the CO2 emission amount and the power consumption amount for a user who operates a device. Further, it is recommendable for a user to select two-sided printing and aggregate printing in each operation of the device to reduce the CO2 emission amount, the power consumption amount, and the amount of sheets to be used.

For example, as discussed in Japanese Patent Application Laid-Open No. 2003-150695, a copying machine may calculate and display a CO2 emission amount based on print conditions when a printing/copying operation is performed. Further, a technique capable of displaying print conditions to be satisfied with respect to the upper limit of printing is discussed. According to the above-described technique, a user may check how the CO2 emission amount will change depending on the print conditions of each printing operation that will be performed.

When a printing/copying operation is performed, the system discussed in Japanese Patent Application Laid-Open No. 2003-150695 calculates the number of printed pages and the number of sheets required in the two-sided printing and the aggregate printing with reference to information of each original document. However, the operation performed by the above-described system will be insufficient to reduce the environmental burden. For example, with respect to printing/copying operations already performed in an entire office, it is desired to obtain information relating to the two-sided printing and the aggregate printing and further obtain information indicating possible reduction amounts with respect to the greenhouse effect gas (e.g., CO2) emission amount, the power consumption amount, and the used sheet amount.

### SUMMARY OF THE INVENTION

One disclosed aspect of the embodiments relates to a technique for analyzing a possible change in the environmental burden in a case where a setting change is applied to an actually executed job and letting a user confirm the results.

According to an aspect of the embodiments, an information processing apparatus having a storage device and configured to collect job history information recording a content of a plurality of jobs executed by an image forming apparatus includes a counting unit configured to count as a result the number of sheets output by the image forming apparatus with reference to the job history information, a first storing unit configured to store an amount of power consumed by the image forming apparatus, including an amount of electric power consumed for execution of a job, which may be obtained based on the job history information, in the storage device, a second storing unit configured to store an emission amount of greenhouse effect gases that may be obtained based on the number of sheets counted by the counting unit and an emission amount of greenhouse effect gases that may be obtained based on the power consumption amount stored in the first storing unit in the storage device, a generation unit configured to generate display data required to display a screen indicating the emission amount of the greenhouse effect gas that may be obtained based on the number of sheets and the emission amount of the greenhouse effect gas that may be obtained based on the power consumption amount which are stored by the second storing unit, and an analysis unit configured to analyze the number of sheets that will be output by the image forming apparatus if at least either one of an aggregate print setting and a two-sided print setting is applied to a job corresponding to a history included in the job history information, wherein the generation unit is configured to generate the display data required to display the screen in such a way as to indicate the emission amount of the greenhouse effect gas that may be obtained based on the number of sheets analyzed by the analysis unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an environmental burden analyzing system according to a first exemplary embodiment of the present invention.

FIG. 2 illustrates an internal configuration of a host computer according to the exemplary embodiment of the present invention.

FIG. 3 illustrates a functional configuration of the host computer according to the exemplary embodiment of the present invention.

FIG. 4 illustrates a functional configuration of an analysis server according to the exemplary embodiment of the present invention.

FIG. 5 illustrates an internal configuration of an image forming apparatus according to the exemplary embodiment of the present invention.

FIG. 6 illustrates a functional configuration of the image forming apparatus according to the exemplary embodiment of the present invention.

FIGS. 7A to 7C illustrate examples of a job history information table, a printed page information table, and a job history sheet information table according to the exemplary embodiment of the present invention.

FIGS. 8A and 8B illustrate examples of a power consumption table and a sheet CO2 emission amount table according to the exemplary embodiment of the present invention.

FIG. 9 (including FIG. 9A and FIG. 9B) illustrates an example of a summary table according to the exemplary embodiment of the present invention.

FIG. 10 is a flowchart illustrating an example processing procedure of CO2 emission amount analysis processing according to the exemplary embodiment of the present invention.

FIG. 11 is a flowchart illustrating a detailed processing procedure of job power consumption amount and CO2 emission amount analysis processing (step S1302) according to the exemplary embodiment of the present invention.

FIG. 12 is a flowchart illustrating a detailed processing procedure of sheet originated CO2 emission amount analysis processing (step S1303) according to the exemplary embodiment of the present invention.

FIG. 13 is a flowchart illustrating a detailed processing procedure of print setting changed number of pages and number of sheets calculation processing (step S1306) according to the exemplary embodiment of the present invention.

FIG. 14 (including FIG. 14A and FIG. 14B) is a flowchart illustrating a detailed processing procedure of aggregate print setting changed number of pages calculation processing (step S1605) according to the exemplary embodiment of the present invention.

FIG. 15 is a flowchart illustrating a detailed processing procedure of two-sided print setting changed number of sheets and number of two-sided printing sheets calculation processing (step S1606) according to the exemplary embodiment of the present invention.

FIGS. 16A and 16B illustrate examples of a printed page information table after calculating the number of pages applicable to a change of aggregate print setting and a job history information table applicable to a change of reduction print setting according to the exemplary embodiment of the present invention.

FIG. 17 illustrates an example of a display screen indicating analysis results of the power consumption amount and the CO2 emission amount according to the exemplary embodiment of the present invention.

FIGS. 18A and 18B illustrate examples of a device information table and a device state power consumption table according to the example embodiment of the present invention.

FIGS. 19A and 19B illustrate examples of an application type oriented print setting table and a management code oriented print setting table according to the example embodiment of the present invention.

FIG. 20 illustrates an example of a CO2 emission amount counting result display screen according to a second exemplary embodiment of the present invention.

FIG. 21 illustrates an example of a device map information table according to the second exemplary embodiment of the present invention.

### DESCRIPTION OF THE EMBODIMENTS

Various exemplary embodiments, features, and aspects of the invention will be described in detail below with reference to the drawings. The embodiment which will be described below does not restrict to the invention according to the claims. All of combinations of the features described in the embodiment are not always essential to the means for solution according to the invention.

One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

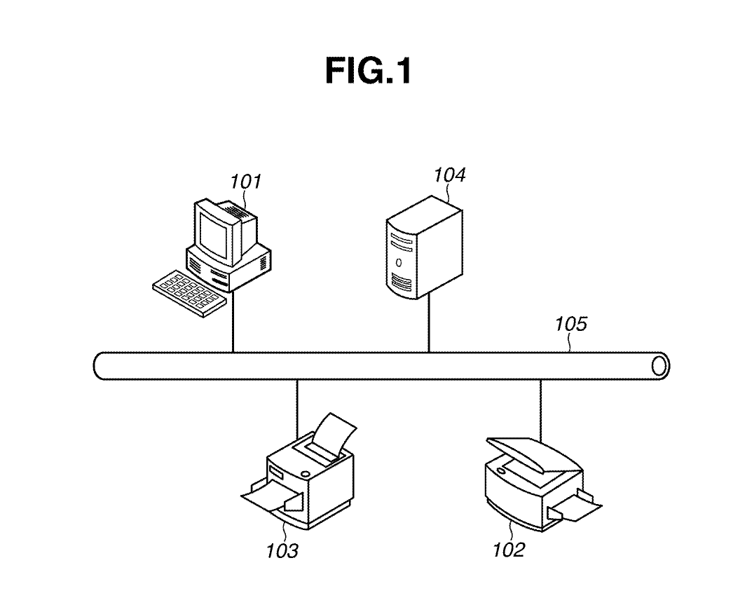

### [Overall Configuration of Environmental Burden Analyzing System (See FIG. 1)]

An analyzing system that analyzes an environmental burden according to a first exemplary embodiment of the present invention includes a host computer 101, image forming apparatuses 102 and 103, and an analysis server 104. The host computer 101, the image forming apparatuses 102 and 103, and the analysis server 104 are connected each other to mutually communicate via a network 105 according to Ethernet (registered trademark) or another conventionally known technique.

The host computer 101 enables a user to generate image data and input print instructions. Each of the image forming apparatuses 102 and 103 is a printing device that may receive print data via the network 105 and perform printing on an actual sheet using a conventionally known printing technique, such as an electrophotographic technique or an inkjet technique. Each of the image forming apparatuses 102 and 103 has the capability of reading a paper original via a scanner, performing a copying operation, and transmitting an e-mail including converted image data. The image forming apparatuses 102 and 103 may be a simple printer that does not have any scanning function. The analysis server 104 performs power consumption analysis on the image forming apparatuses 102 and 103.

In the present exemplary embodiment, the analysis server 104 is provided as an independent server different from the image forming apparatuses 102 and 103. However, the image forming apparatuses 102 and 103 may be configured to include a module having a similar function. In this case, network communications to be performed between the analysis server 104 and the image forming apparatuses 102 and 103 are replaced by data transmission/reception via an internal system bus.

### [Configuration of Host Computer 101]

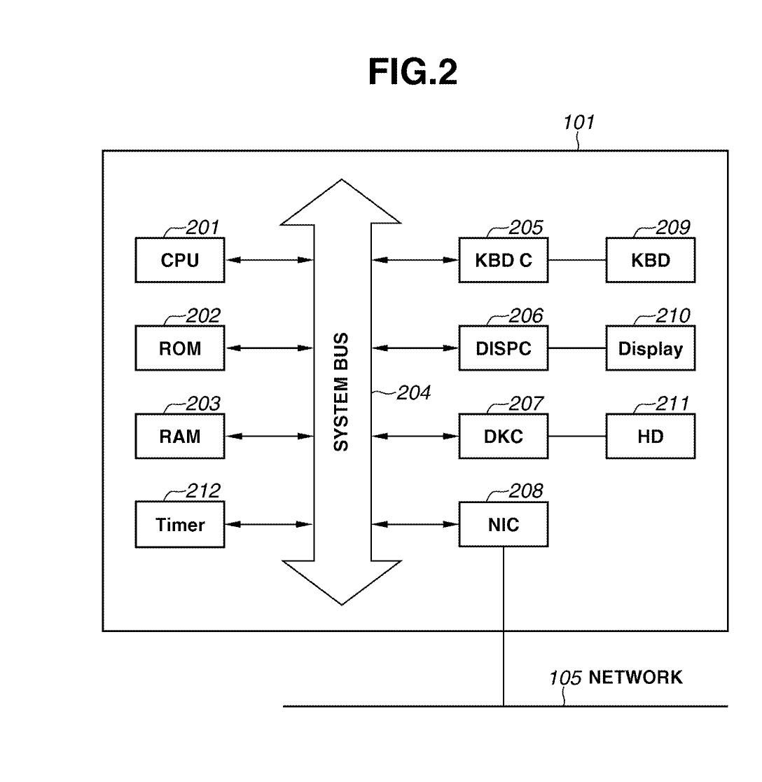

An example hardware configuration of the host computer (i.e., an information processing apparatus) is described below with reference to FIG. 2.

The host computer 101 includes a central processing unit (CPU) 201 that may execute a software program stored in a read only memory (ROM) 202 or a hard disk 211 (i.e., a large-scale storage device). The CPU 201 may comprehensively control operations to be performed by devices connected to a system bus 204. A random access memory (RAM) 203 is functionally operable as a main memory or a work area for the CPU 201. A keyboard controller (KBDC) 205 may control each instruction input via a keyboard 209 provided for the host computer 101.

A display controller (DISPC) 206 may control a display of a display module (DISPLAY) 210 that may be, for example, constituted by a liquid crystal display device. A disk controller (DKC) 207 may control the hard disk (HD) 211. A network interface card (NIC) 208 may perform bidirectional data transmission and reception, via the network 105, with other node.

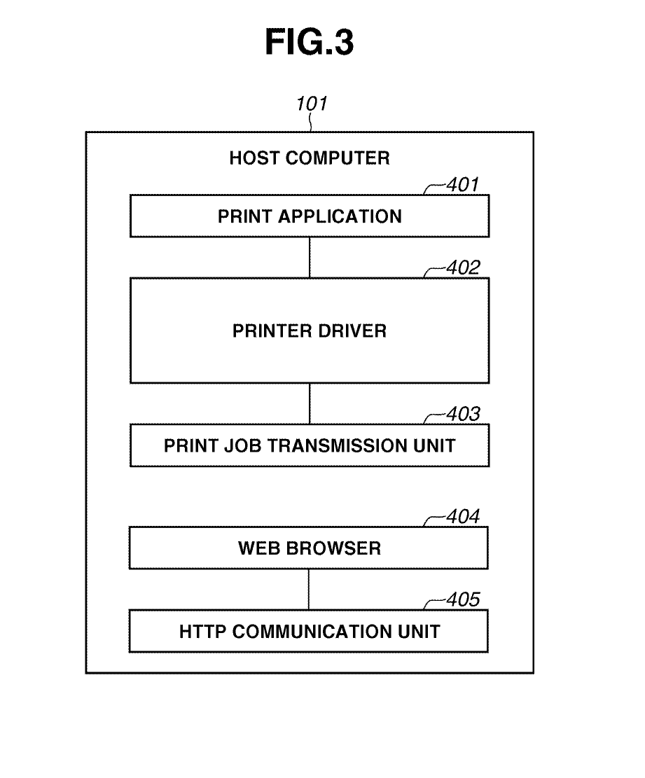

A functional configuration of the host computer 101 is described below with reference to FIG. 3. The host computer 101 includes a print application 401, a printer driver 402, a print job transmission unit 403, a web browser 404, and a hypertext transfer protocol (HTTP) communication unit 405. The print application 401 may instruct a printing operation by transmitting a drawing command to the printer driver 402.

The printer driver 402 may convert each drawing command received from the print application 401 into print data that may be interpreted by the image forming apparatus, i.e., Page Description Language (PDL). Further, the printer driver 402 may display a user authentication dialog if a device authentication is set and may request a user to input a user name and a password as information required to use the image forming apparatus. In this case, the printer driver 402 transmits the input user name and the password to the image forming apparatus (i.e., a print destination) via the network 106 to request authentication.

The image forming apparatus causes an authentication processing unit 612 to check the input user name and the password and return an authentication result. The printer driver 402 cancels the printing operation if the authentication failed. If the authentication was successful, the printer driver 402 generates a print job by adding the input user name as job owner information to the print job. If no device authentication is set, the printer driver 402 generates a print job by adding a log-in user name of the host computer 101 as job owner information to the print job.

Subsequently, the printer driver 402 refers to a management code input requirement setting that has been set by a setting unit (not illustrated) and, if the management code input is required, the printer driver 402 displays a management code input screen. The management code is a code arbitrarily usable to designate a charging target or the purpose of printing. If a user inputs the management code, the printer driver 402 adds the input management code to the job.

Subsequently, the printer driver 402 transmits the generated print job data to the print job transmission unit 403. The print job transmission unit 403 transmits the print job received from the printer driver 402 to the image forming apparatus. The web browser 404 may interpret hypertext markup language (HTML) data and cause the display module 210 to perform screen rendering. Further, the web browser 404 may receive a user operation input via the keyboard and transmit a request to the HTTP communication unit 405. In response to the communication request from the web browser 404, the HTTP communication unit 405 communicates with the image processing apparatus via the NIC 208 using the HTTP or hypertext transfer protocol security (HTTPS) protocol to request a web page and receive web page data.

### [Configuration of Analysis Server 104]

An internal hardware configuration of the analysis server 104 is similar to that of the host computer 101 (see FIG. 2).

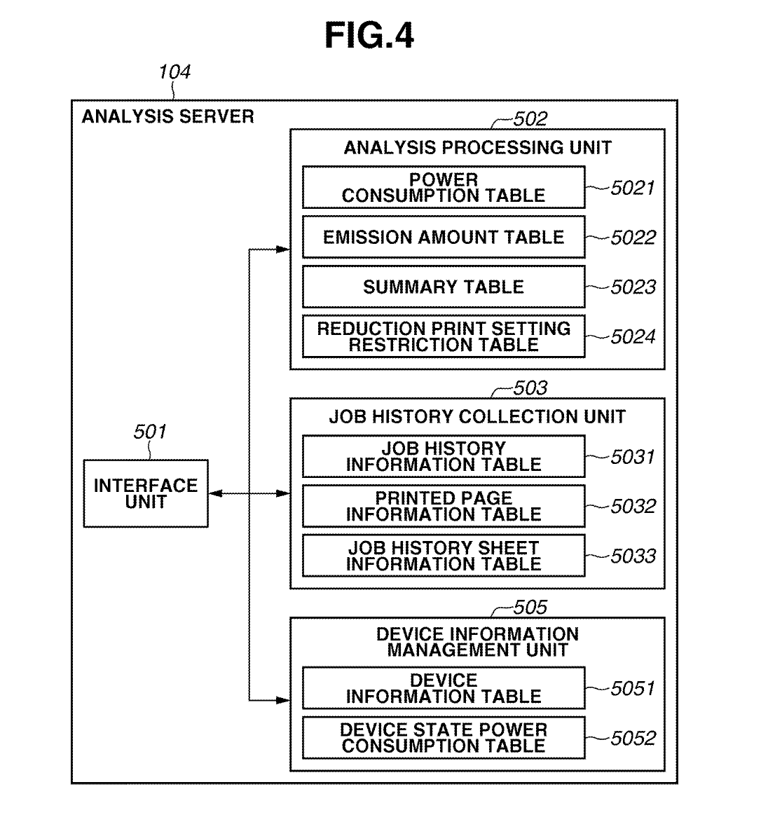

A functional configuration of the analysis server 104 is described below with reference to FIG. 4. The analysis server 104 includes an interface unit 501, an analysis processing unit 502, a job history collection unit 503, and a device information management unit 505. The interface unit 501 may communicate with the image forming apparatuses 102 and 103 via the NIC 208 and the network 105. The analysis processing unit 502 may analyze the amount of electric power consumed by each image forming apparatus based on job history and power state history. The job history collection unit 503 may collect job history from the image forming apparatuses 102 and 103 via the interface unit 501 and store the collected job history. The device information management unit 505 may acquire capability information and setting information from the image forming apparatuses 102 and 103 via the interface unit 501 and store the acquired information.

### [Configuration of Image Forming Apparatuses 102 and 103]

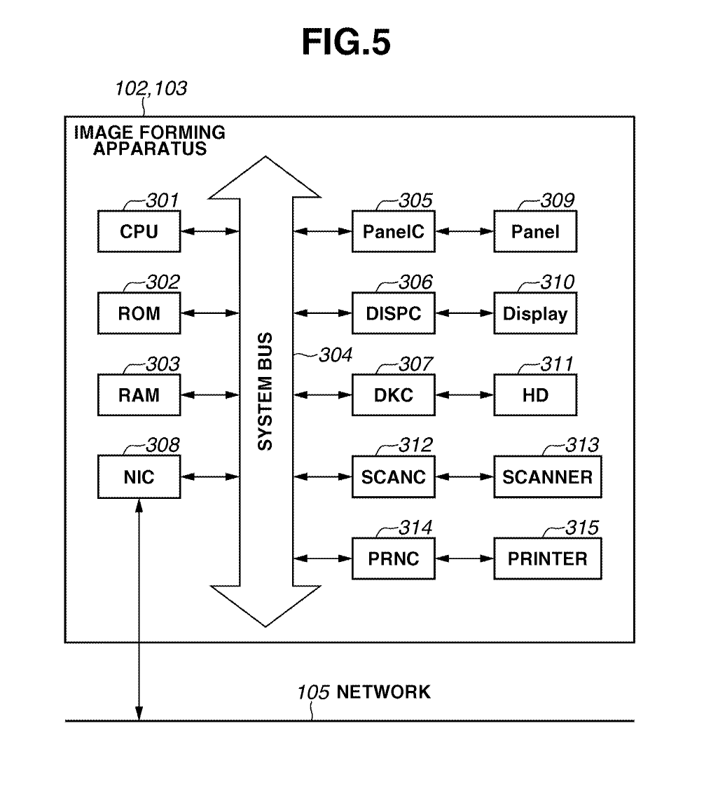

An example hardware configuration of the image forming apparatuses 102 and 103 is described below with reference to FIG. 5. The image forming apparatus includes a CPU 301 that may execute a software program stored in a ROM 302 or a hard disk 311 (i.e., a large-scale storage device). The CPU 301 may comprehensively control operations to be performed by devices connected to a system bus 304. A RAM 303 is functionally operable as a main memory or a work area for the CPU 301. A panel controller (PanelC) 305 may control each instruction input via an operation panel 309 provided on each of the image forming apparatuses 102 and 103. A display controller (DISPC) 306 may control a display of a display module (DISPLAY) 310 that may be, for example, constituted by a liquid crystal display device.

A disk controller (DKC) 307 may control the hard disk (HD) 311, which is a mass storage device. A network interface card (NIC) 308 may perform data transmission and reception, via the network 105, with other node. A scanner controller (SCANC) 312 may control an optical scanner 313 provided in the image forming apparatuses 102 and 103 to read a paper original. A printer controller (PRNC) 314 may control a printer 315 provided in the image forming apparatuses 102 and 103 to perform printing on an actual sheet using a conventionally known printing technique, such as an electrophotographic technique or an inkjet technique.

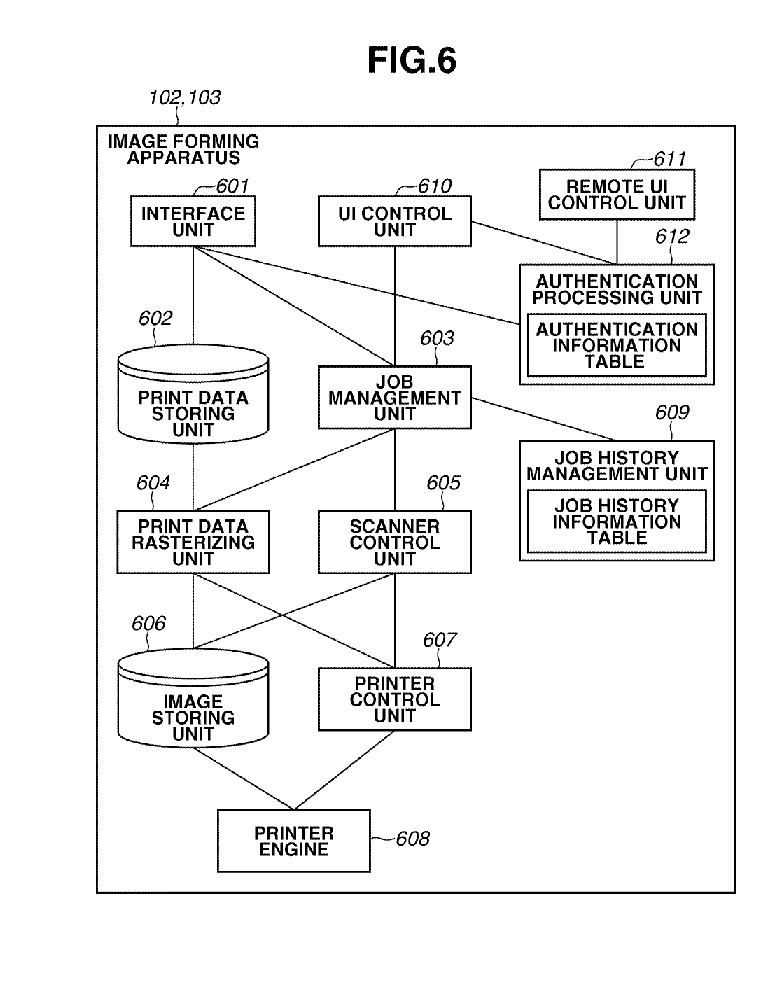

A functional configuration of the image forming apparatuses 102 and 103 is described with reference to FIG. 6. An interface unit 601 is connected to the network 105. The interface unit 601 may receive a print job from the host computer 101 and may notify the analysis server 104 of a power state. Further, the interface unit 601 may transmit job history information in response to a job history acquisition request received from the analysis server 104. A print data storing unit 602 temporarily stores the print job data in the RAM 303 or in the hard disk (HD) 311.

A user interface (UI) control unit 610 may control the operation panel 309 via the panel controller (PanelC) 305 to receive a log-in request, a copy instruction, or a scan and transmission instruction input by a user of the image forming apparatuses 102 and 103. If the UI control unit 610 receives a log-in request from a user, the UI control unit 610 transmits authentication information (e.g., user name and password) to the authentication processing unit 612 to request authentication. If the authentication by the authentication processing unit 612 is successful, the UI control unit 610 receives an authentication ID.

Subsequently, the UI control unit 610 refers to the management code input requirement setting that has been set by the setting unit (not illustrated) and, if the management code input is required, the UI control unit 610 displays the management code input screen. If a user inputs the management code, the UI control unit 610 stores the input management code. The UI control unit 610 stores the user name, the authentication ID, and the management code until a log-out request is received. If a user instructs a job issuance (e.g., copy), the UI control unit 610 transmits a job issuance request together with the user name, the authentication ID, and the management code to a job management unit 603. Further, if the user operates the operation panel to log out, the UI control unit 610 performs log-out processing.

The UI control unit 610 has “timeout time” information as operation setting information and, if no operation is performed before the “timeout time” set on the operation panel, the UI control unit 610 performs log-out processing. A “timeout time” setting value may be referred to by an external module (e.g., the analysis server). In the log-out processing, the UI control unit 610 transmits a log-out notification together with the user name, the authentication ID, and log-out factor information to the authentication processing unit 612 and discards the authentication information and the authentication ID.

The job management unit 603 may analyze a print job to acquire output attribute information, such as a user name, a management code, the number of copies of prints, and color print. The job management unit 603 manages the acquired output attribute information together with job start time information as job information. If a job (e.g., print job) is issued via the operation panel, the job management unit 603 receives the output attribute information and the user name from the UI control unit 610. If a job is issued via the web browser, the job management unit 603 receives the output attribute information and the user name from a remote UI control unit 611.

A print data rasterizing unit 604 may acquire print data from the print data storing unit 602 according to the job information stored in the job management unit 603. The print data rasterizing unit 604 performs image generation processing based on the acquired print data and generates image data. A scanner control unit 605 may control the scanner controller 312 to scan a paper original and generate image data. An image storing unit 606 may temporarily store the image data generated by the print data rasterizing unit 604 and the scanner control unit 605 in the RAM 303 or in the hard disk (HD) 311.

A printer control unit 607 may control a printer engine to perform printing of image data stored in the image storing unit 606. A printer engine 608 is a printer device that may actually print the image data stored in the image storing unit 606 on a printing sheet or other recording medium using a conventionally known printing technique, such as an electrophotographic technique or an inkjet technique.

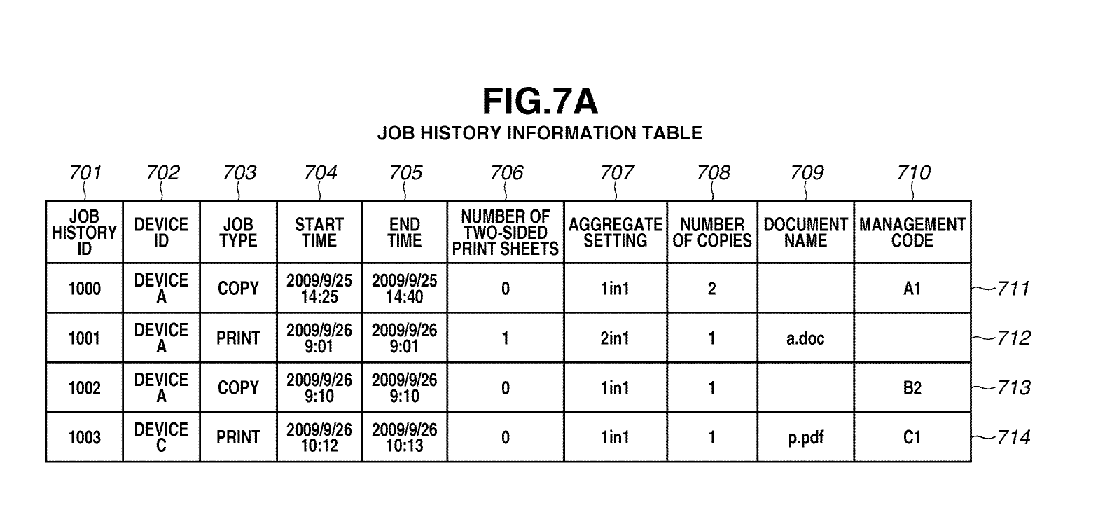

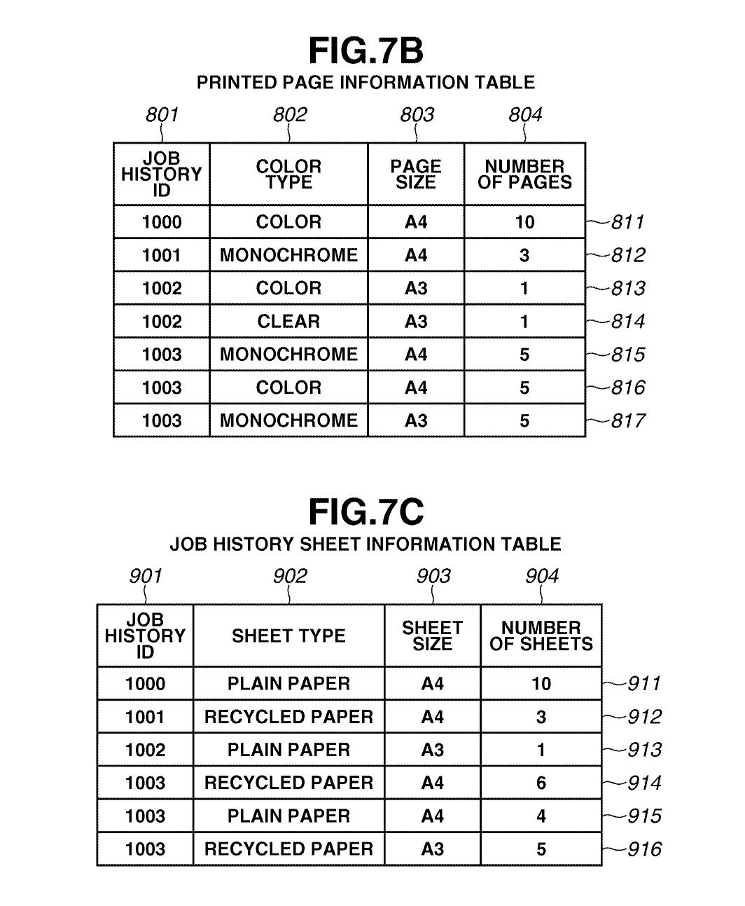

A job history management unit 609 may manage various information including job history information described below with reference to FIG. 7. If the job completes, the job management unit 603 transmits the managed job information as job history information to the job history management unit 609. The job history management unit 609 stores the received job history information. The job history management unit 609 transmits the job history information to the analysis server 104 in response to a request from the analysis server 104.

The remote UI control unit 611 is functionally operable as an HTTP or HTTPS server, which receives a request from the web browser 404 operating on the host computer 101. The remote UI control unit 611 acquires authentication information from session information in response to a request received from the web browser and inquires the authentication processing unit 612 about accessibility.

The remote UI control unit 611 transmits, if access is permitted, requested HTML data to the web browser and transmits, if access is not permitted, HTML data used to display a log-in form screen to the web browser. If the remote UI control unit 611 receives input data of a log-in form from the web browser 404, the remote UI control unit 611 transmits an authentication request to the authentication processing unit 612 and transmits, if authentication is successful, the requested HTML data to the web browser.

The authentication processing unit 612 performs authentication processing and management for the image forming apparatuses 102 and 103. The authentication processing unit 612 performs user authentication based on the log-in name and the password that are input by the user via the operation panel 309 or the log-in form of the web browser 404. Further, the authentication processing unit 612 receives an authentication request from the printer driver 402 and checks the user name and the password. If authentication is successful, the authentication processing unit 612 issues the authentication ID and returns the authentication result together with the issued authentication ID to the operation panel 309 or to the web browser 404.

The authentication processing unit 612 stores an authentication information table and performs user authentication based on a comparison between the user information (i.e., user name and password) and the information registered in the authentication information table. The authentication processing unit 612 may communicate with an authentication server (not illustrated) to perform user authentication using an authentication information table stored in the authentication server.

A job history information table, a printed page information table, and a job history sheet information table are described in detail below with reference to FIGS. 7A to 7C.

FIG. 7A illustrates an example of the job history information table. The job history information table illustrated in FIG. 7A is described below. A “job history ID” column 701 stores ID information that may uniquely identify each job history in the system. A “device ID” column 702 stores ID information that may identify each image forming apparatus. For example, a MAC address or an Internet protocol (IP) address is usable as the device ID. A “job type” column 703 stores the type of each job, e.g., print, i.e., a print job from the host computer 101, copy, scan, fax, and box print, i.e., printing of a document stored in the image forming apparatus.

A “number of two-sided print sheets” column 706 stores the number of sheets printed according to a job that designates two-sided printing. For example, if the job designates two-sided printing on original data including four pages, two continuous pages are printed on the front and rear surfaces of one output sheet and, as a result, a print product includes a total of two physical sheets is output. In this case, the number of two-sided print sheets is equal to two. Instead of using the number of two-sided print sheets in the column 706, it may be useful to record whether the job has been completed according to the two-sided setting. If the number of two-sided print sheets is one or more, it may be understood that the two-sided printing has been performed.

An “aggregate setting” column 707 stores an aggregate print setting set for each job. If the aggregate setting in the column 707 is “2in1”, it indicates that the aggregate print has been performed in such a way as to print original data including two pages (the number of logical pages is two) on one surface (the number of physical page is one) of an output sheet. Alternatively, it is useful to record the number of aggregate printed sheets. A “number of copies” column 708 stores the number of copies designated for each job.

A “document name” column 709 stores a document name set for each job by the print application 401 of the job. The type of the print application may be identified to some extent based on the document name. A “management code” column 710 stores a code that may be arbitrarily added by a user for each job. The management code indicates, for example, the purpose of printing. The management code may be designated via a management code designation dialog (not illustrated) to be displayed if printing is instructed by the print application 401 or via an authentication screen of the UI control unit 610.

FIG. 7B illustrates an example of the printed page information table. The printed page information table illustrated in FIG. 7B is described below. The printed page information table may be used to record detailed information relating to printed pages of the job history information stored in the job history information table.

A “job history ID” column 801 stores ID information that may uniquely identify each job history in the system. The job history ID 801 is associated with the job history ID 701 when they have the same ID information. Job histories 711 and 811 are associated with each other because they have the same job history ID (701, 801) of 1000. Printed page information of the job history 811 describes detailed information about a page printed for the job of the job history 711.

The information in a “color type” column 802 indicates whether the type of printing is color, monochrome, or clear (i.e., special printing using transparent coloring materials providing gross effects). Although not illustrated, it is useful to set an attribute, such as single color, two colors, or silver, to indicate a printing method. A “page size” column 803 stores the size of each printed page, such as A4, B5, or any other predefined sheet size. The data in the “page size” column 803 may be expressed using the format of height*width. A “number of pages” column 804 stores the number of pages which were printed based on the data in the “color type” column 802 and the “page size” column 803 of the job.

If the printing designated for one job includes a plurality of color types and page sizes, the data in the “color type” column 802 and the “page size” column 803 are recorded for each of a plurality of rows. For example, job histories 815, 816, and 817 indicate detailed information about a job having the job history ID 1003. According to the detailed information illustrated in FIG. 7B, five pages were printed in monochrome with A4 size (the job history 815), five pages were printed in color with A4 size (the job history 816), and five pages are printed in monochrome with A3 size (the job history 817). Thus, the total number of printed pages is fifteen.

FIG. 7C illustrates an example of the job history sheet information table. The job history sheet information table illustrated in FIG. 7C is described below. The job history sheet information table may be used to record detailed information relating to the number of printed sheets of the job history information stored in the job history information table.

A “job history ID” column 901 stores ID information that may uniquely identify each job history in the system. Similar to the “job history ID” column 801, the job history ID in the column 901 is associated with the job history ID in the column 701 when they have the same ID. A “sheet type” column 902 stores the type of each sheet used in the printing (e.g., plain paper, recycled paper, etc.). A “sheet size” column 903 stores the size of each sheet used in the printing, such as A4, B5, or any other predefined sheet size. The data in the “sheet size” column 903 may be expressed using the format of height*width. A “number of sheets” column 904 stores the number of sheets which were printed based on the data in the “sheet type” column 902 and the “sheet size” column 903 of the job.

If the printing designated for one job includes a plurality of sheet types and sheet sizes, data of the “sheet type” column 902 and the “sheet size” column 903 are recorded for each of a plurality of rows. For example, job histories 914, 915, and 916 indicate detailed information about the job having the job history ID 1003. According to the detailed information illustrated in FIG. 7C, six sheets were printed using recycled paper with A4 size (the job history 914), four sheets were printed using plain paper with A4 size (the job history 915), and five sheets were printed using recycled paper with A3 size (the job history 916). The total number of printed sheets is fifteen.

According to the information illustrated in FIGS. 7A to 7C, for example, the job history 711 indicates that the image forming apparatus A (i.e. a device A) has started a copy job at the time 2009/09/25_{—}14:25:30 and ended the job at the time 2009/09/25_{—}14:40:30. Further, in this job, the device A has printed ten A4 color pages using ten A4 plain papers. In the present exemplary embodiment, it may be useful to generate the job history information table, the printed page information table, and the job history sheet information table for each job type.

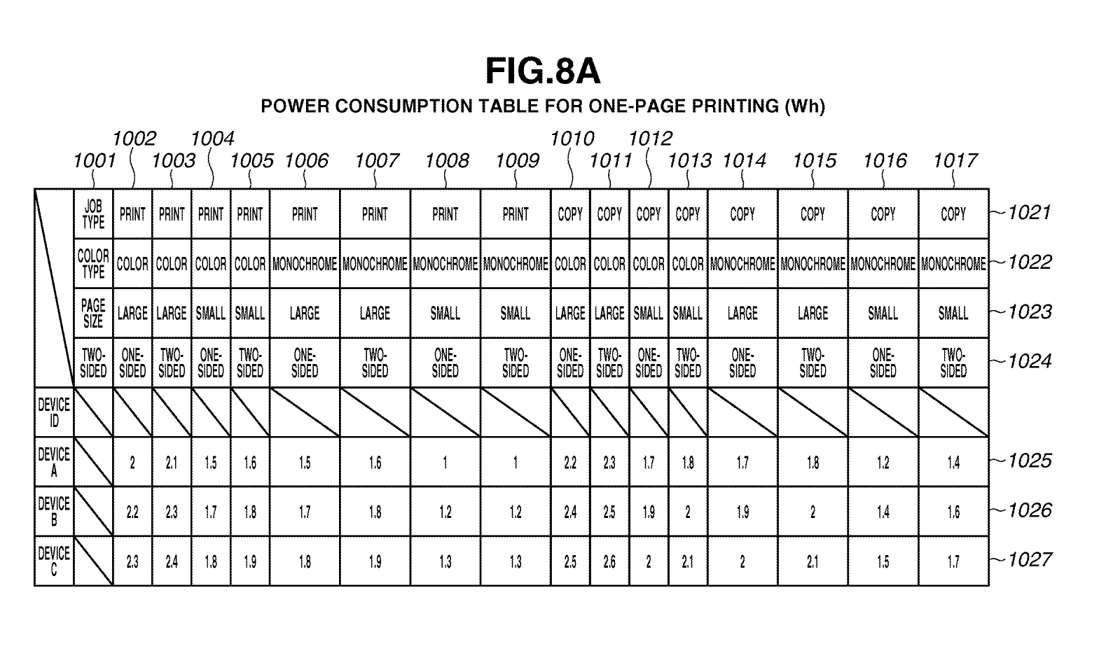

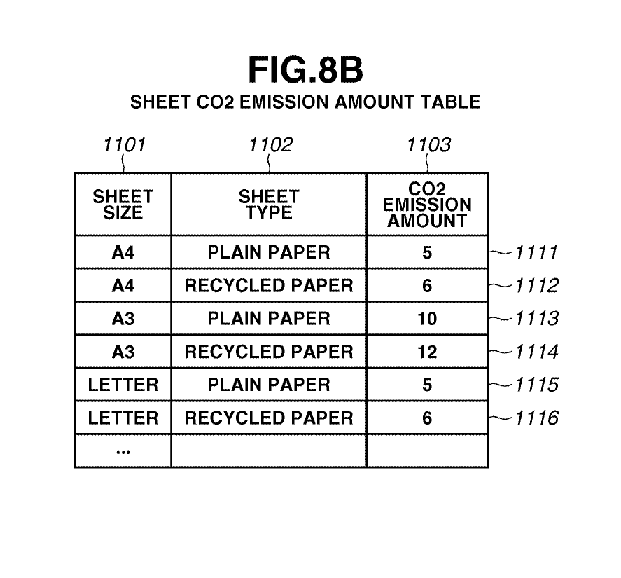

Example tables that may be managed by the analysis processing unit 502 are described below with reference to FIGS. 8A and 8B.

FIG. 8A is an example of a power consumption table in printing. The power consumption table illustrated in FIG. 8A is described below. The power consumption table is usable to store a power consumption amount required to perform one-page printing for each image forming apparatus.

A “device ID” column 1001 stores ID information that may identify each image forming apparatus. A “job type” column 1021 stores the type of each job (e.g., print or copy). A “color type” column 1022 stores the type of printing (e.g., color print, monochrome print, or clear print (not illustrated)). A “page size” column 1023 stores the size of each printed page. In this example, page size is classified in Large and Small.

Alternatively, the sheet size may be designated by practical dimensions, such as A4 or B5. In the present exemplary embodiment, the paper size equal to or greater than B4 is classified into the size “Large”, and the paper size smaller than B4 is classified into the size “Small.” A “two-sided” column 1024 stores the way of printing (e.g., two-sided printing or one-sided printing).

For example, table data 1002 indicates electric power consumption required for one-page printing in a case where the job type is “print”, the color type is “color”, the page size is “Large”, and the printing is performed by the one-sided printing. In this case, the power consumption amount by the image forming apparatus A (i.e. the device A) is 2 Wh. The power consumption is variable depending on each model of the device and the presence of optional setting. Therefore, the power consumption amount is independently settable for each individual device.

FIG. 8B illustrates an example of a sheet CO2 emission amount table. The sheet CO2 emission amount table is described below. In the present invention, CO2 is an example of the greenhouse effect gas. The sheet CO2 emission amount table illustrated in FIG. 8B stores the amount of CO2 emitted when a sheet is used. More specifically, the sheet CO2 emission amount table is usable to designate the amount of CO2 emitted in the manufacturing of a sheet or the substantial CO2 emission amount calculated considering the environmental burden (i.e., the emission amount converted from the amount of CO2 absorbed by trees).

A “sheet size” column 1101 stores the size of each sheet (e.g., A4). A “sheet type” column 1102 stores the type of each sheet (e.g., plain paper, recycled paper, thick paper, or coated paper). A “CO2 emission amount” column 1103 stores the amount of CO2 emitted when a sheet having the sheet size 1101 and the sheet type 1102 is used. The units [g] (gram) and [oz] (ounce) are usable for the CO2 emission amount. In the present exemplary embodiment, the CO2 emission amount is expressed in terms of the unit [g]. For example, table data 1111 indicates that 5 grams of CO2 is emitted when a piece of A4 plain paper is used.

### [Job History Collection Processing]

The job history collection unit 503 of the analysis server 104 communicates with the image forming apparatuses 102 and 103 via the interface unit 501 to collect job history information managed by the job history management unit 609. The acquired job history is stored in the job history collection unit 503 in a table having a format equivalent to (or expanded from) the job history information table illustrated in FIG. 7A, the printed page information table illustrated in FIG. 7B, and the job history sheet information table illustrated in FIG. 7C. In a case where the job history collection unit 503 collects job history information from a plurality of image forming apparatuses, it is useful that the table includes an additional row that stores an identifier allocated to each image forming apparatus.

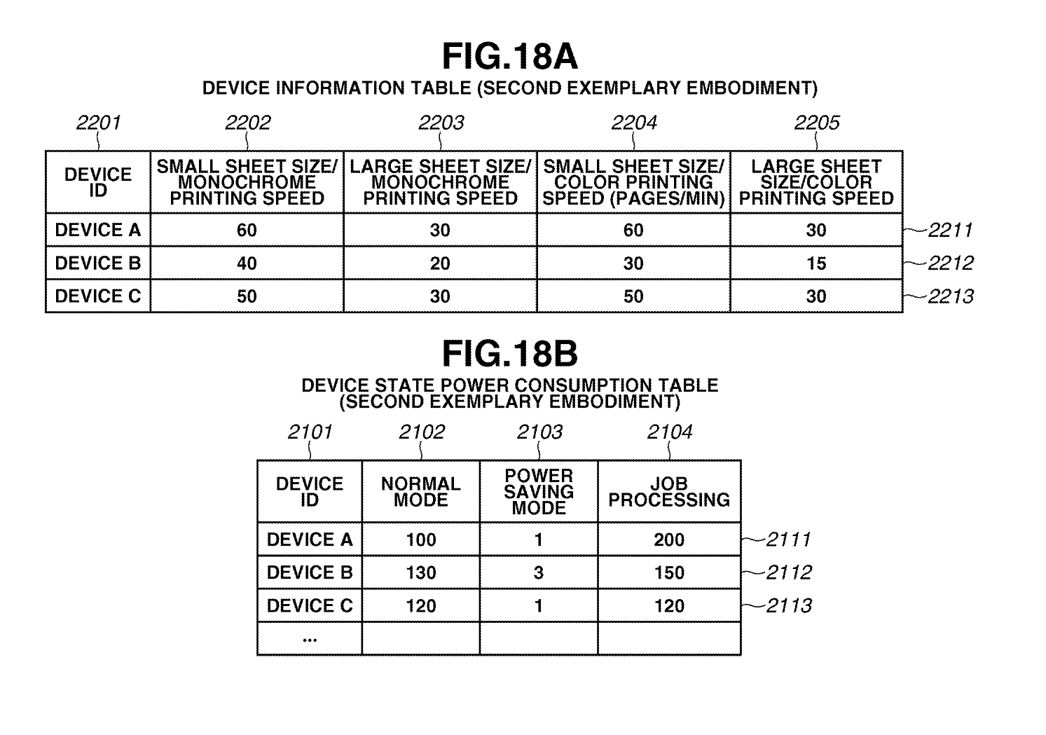

Example tables that may be managed by the device information management unit 505 are described below with reference to FIGS. 18A and 18B.

FIG. 18A illustrates an example of a device information table. The device information table illustrated in FIG. 18A is usable to store various pieces of setting information and capability information of each image forming apparatus. A “device ID” column 2201 stores ID information that may identify each image forming apparatus. Setting data in each row relates to an image forming apparatus that may be identified by the device ID. A “small sheet size/monochrome printing speed” column 2202 stores the printing speed (pages/min) in a case where the image forming apparatus performs printing of a monochrome page having a small sheet size.

A “large sheet size/monochrome printing speed” column 2203 stores the printing speed (pages/min) in a case where the image forming apparatus performs printing of a monochrome page having a large sheet size. A “small sheet size/color printing speed” column 2204 stores the printing speed (pages/min) in a case where the image forming apparatus performs printing of a color page having a small sheet size. A “large sheet size/color printing speed” column 2205 stores the printing speed (pages/min) in a case where the image forming apparatus performs printing of a color page having a large sheet size.

For example, according to data 2211 of the image forming apparatus A (the device A) in the device information table illustrated in FIG. 18A, the image forming apparatus A (the device A) has the following printing speeds. The device information management unit 505 may acquire the above-described information from the image forming apparatus via the network, for example, using the simple network management protocol (SNMP) protocol.

The small sheet size/monochrome printing speed is 60 pages/min

The large sheet size/monochrome printing speed is 30 pages/min

The small sheet size/color printing speed is 60 pages/min

The large sheet size/color printing speed is 30 pages/min

FIG. 18B illustrates an example of a device state power consumption table. The device state power consumption table illustrated in FIG. 18B is usable to store power consumption of each image forming apparatus in respective operational modes. The power consumption information may be information to be set beforehand in the analysis server or may be acquired from each image forming apparatus via the network, for example, using the SNMP protocol.

A “device ID” column 2101 stores ID information that may identify each image forming apparatus. Setting data in each row relates to the image forming apparatus identified by the device ID. A “normal mode” column 2102 stores the amount of electric power that will be consumed when the image forming apparatus is operating in a normal mode. A “power saving mode” column 2103 stores the amount of electric power that will be consumed when the image forming apparatus is operating in a power saving mode. A “job processing in progress” column 2104 stores the basic amount of electric power that will be consumed when the image forming apparatus is executing job processing. The power consumption during the processing of a job is equal to a sum of a power consumption amount calculated based on the number of pages and a basic power consumption amount in the “job processing in progress” column 2104. The unit usable for the power consumption is, for example, [W] (watt).

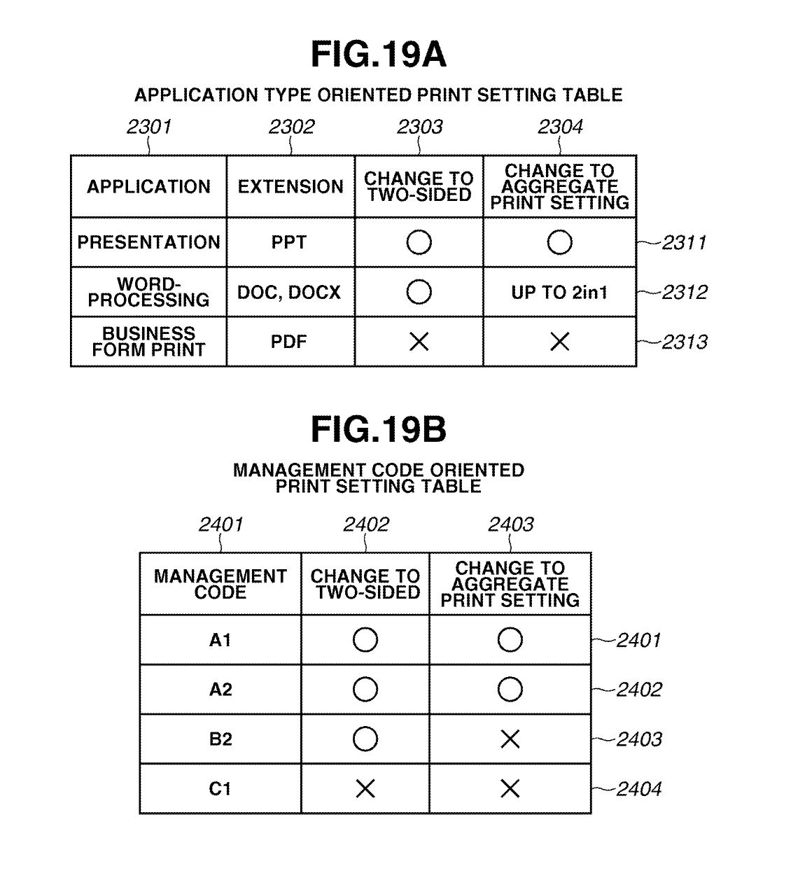

Example tables that may be managed by the analysis processing unit 502 are described below with reference to FIGS. 19A and 19B.

FIG. 19A illustrates an example of a print setting table dedicated to each application type, which is usable to indicate print settings employable to reduce the amount of sheets to be used for each application type.

An “application” column 2301 stores the type of each print application. An “extension” column 2302 stores the extension of a file that the print application may use. The extension is attached to the tail of a job document name. The type of the print application that has printed each job may be identified based on the extension.

A “change to two-sided” column 2303 stores the possibility about the change to two-sided printing as a setting usable to reduce the amount of sheets to be used (i.e., a reduction print setting) in a case where a received print request requires using the print application described in a corresponding row. In this table, the mark “o” indicates “permitted” and the mark “x” indicates “not permitted.” A “change to aggregate print setting” column 2304 indicates the possibility about the change to 2in1 or 4in1 printing as a reduction print setting in a case where a received print request requires using the print application described in a corresponding row. In this table, the mark “o” indicates “permitted”, the mark “x” indicates “not permitted”, and “up to 2in1” indicates that the change to 2in1 printing is permitted and the change to 4in1 printing is not permitted.

For example, the row 2312 includes DOC or DOCX in the “extension” column 2302. The print application of a job that the extension “DOC or DOCX” appears at the end of the document name in the column 709 is “word-processing” in the “application” column 2301. If printing is requested from the application classified into the “word-processing”, the “change to two-sided” is permitted as a reduction print setting and the designation “up to 2in1” is permitted as an aggregate print setting. As described above, when the range of the reduction print setting may be designated according to the type of each print application, conversion of two-sided and 2in1 settings may not be performed as intended in all jobs, and it becomes feasible to change the range flexibly according to the type of each document.

FIG. 19B illustrates an example of a print setting table dedicated to each management code.

A “management code” column 2401 stores a management code allocated to each job. A “change to two-sided” column 2402 stores the possibility about the change to two-sided printing as a reduction print setting in a case where a received job designates the management code described in a corresponding row. In this table, the mark “o” indicates “permitted” and the mark “x” indicates “not permitted.” A “change to aggregate print setting” column 2403 indicates the possibility about the change to 2in1 or 4in1 printing as a reduction print setting in a case where a received job designates the management code described in a corresponding row. In this table, the mark “o” indicates “permitted”, the mark “x” indicates “not permitted”, and “up to 2in1” indicates that the change to 2in1 printing is permitted and the change to 4in1 printing is not permitted.

For example, the description in the row 2403 indicates that the two-sided printing is permitted as a reduction print setting and changing the aggregate print setting is not permitted for a job that designates B2 as the management code 2401. As described above, when the range of the reduction print setting may be designated according to the management code, conversion of two-sided and 2in1 settings may not be performed as intended in all jobs, and it becomes feasible to change the range flexibly according to the purpose of printing indicated by the management code.

### [Analysis Processing for Estimating CO2 Emission Amount]

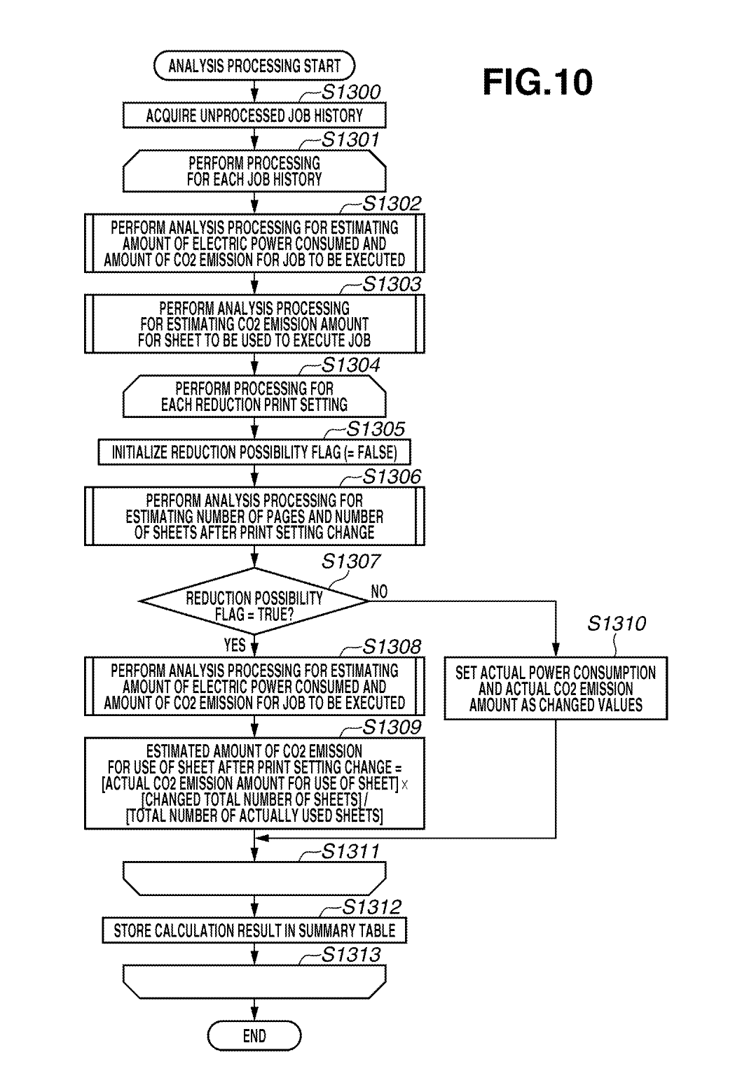

Example CO2 emission amount calculation processing that may be performed by the analysis processing unit 502 of the analysis server 104 is described in detail below with reference to flowcharts illustrated in FIGS. 10 to 15.

FIG. 10 is a flowchart illustrating an overall processing procedure of CO2 emission amount analysis processing. In operation S1300, the analysis processing unit 502 acquires a job history that is not yet subjected to the analysis processing from the job history collection unit 503. The analysis server 104 records a job history ID of each job when the present analysis processing has been completed for the job, and acquires a job history of a subsequent job in the next analysis processing.

Upon receiving a designated job history ID, the job history collection unit 503 collects job history information corresponding to a job history ID that follows the designated job history ID from the job history information table, the printed page information table, and the job history sheet information table. The job history collection unit 503 transmits the collected information to the analysis processing unit 502.

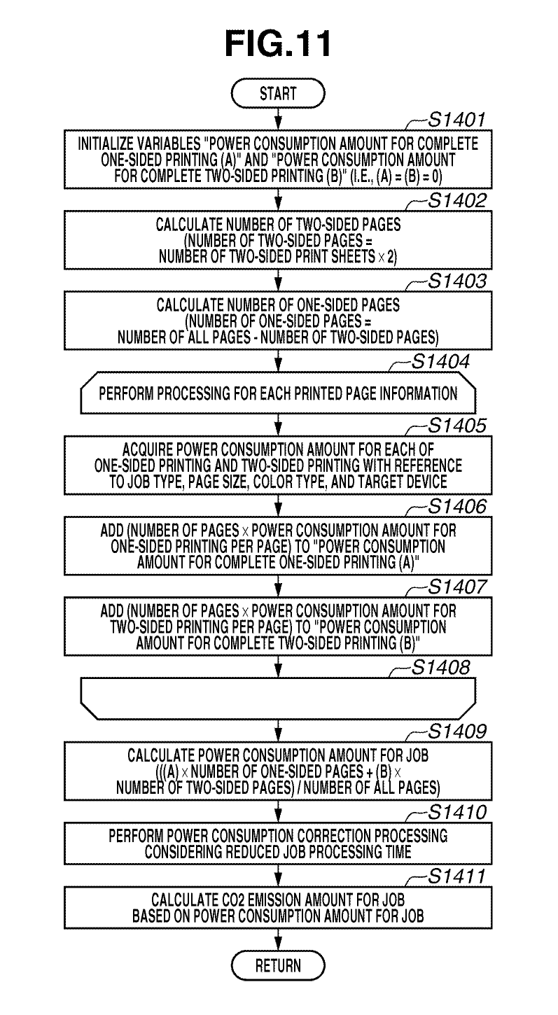

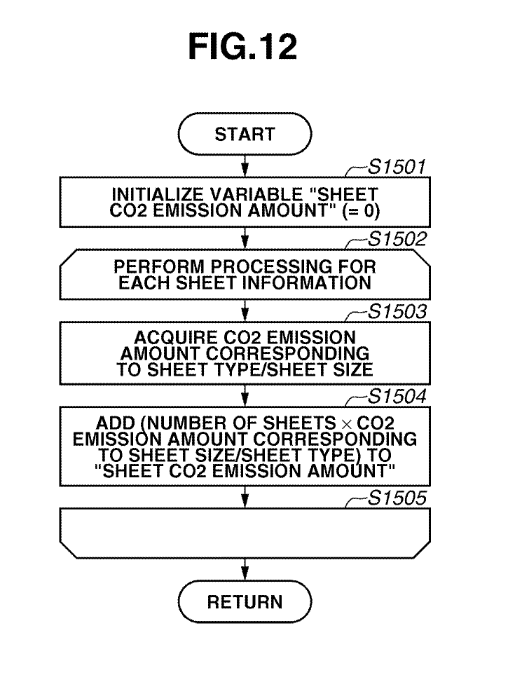

Subsequently, the analysis processing unit 502 performs sequential processing in operation S1301 to operation S1313 for each acquired unprocessed job history. In operation S1302, the analysis processing unit 502 performs analysis processing, based on the acquired job history information, for estimating the amount of electric power that will be consumed when the acquired unprocessed job is executed and the amount of CO2 that will be emitted when the job is executed. The analysis processing to be performed in operation S1302 is described in detail below with reference to FIG. 11. In operation S1303, the analysis processing unit 502 performs analysis processing, based on the job history information, for estimating the amount of CO2 emitted for a sheet to be used to execute the job. The analysis processing to be performed in operation S1303 is described in detail below with reference to FIG. 12. Subsequently, in operation S1304 to operation S1311, the analysis processing unit 502 calculates an estimated reduction in the number of printed pages, number of sheets, power consumption amount, and CO2 emission amount if the print setting of a job recorded in the history is changed. The analysis processing unit 502 repetitively performs the sequential processing in operations S1304 to S1311 for each reduction print setting (e.g., Nin1 print setting (N≧2), two-sided print setting, or combination thereof) that may reduces any one of the number of sheets, the power consumption amount, and the CO2 emission amount.

In operation S1305, the analysis processing unit 502 initializes a reduction possibility flag with FALSE. The reduction possibility flag is a flag indicating the effect of reduction is obtainable by the concerned reduction print setting. If the flag is FALSE, it indicates that the number of printed pages and the number of output sheets may not be reduced by the concerned reduction print setting. If the flag is TRUE, it indicates that the effect of reduction is obtainable.

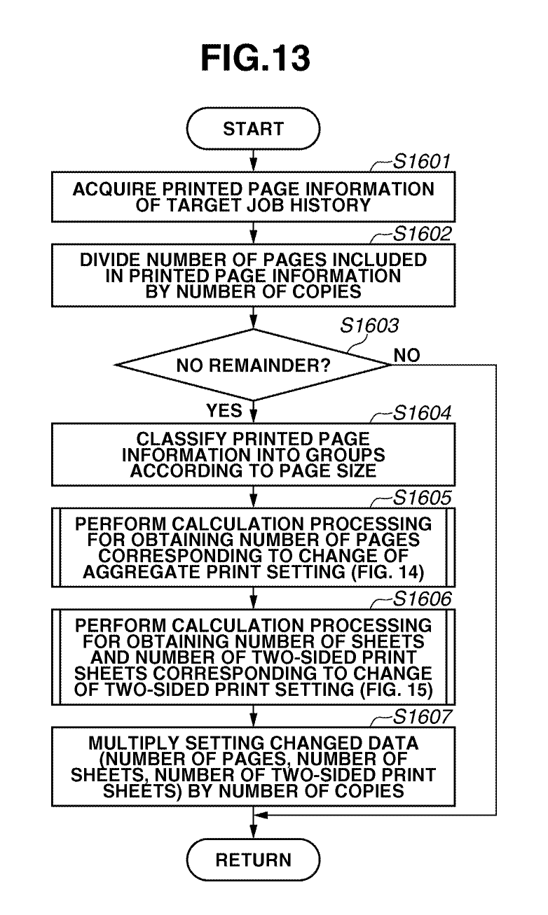

In operation S1306, the analysis processing unit 502 performs analysis processing for estimating the number of pages and the number of sheets after the print setting is changed. The analysis processing to be performed in operation S1306 is described in detail below with reference to FIG. 13.

In operation S1307, the analysis processing unit 502 determines whether the reduction possibility flag is TRUE. If it is determined that the reduction possibility flag is TRUE (YES in operation S1307), the processing proceeds to operation S1308. If it is determined that the reduction possibility flag is not TRUE (NO in operation S1307), the processing proceeds to operation S1310. In operation S1308, the analysis processing unit 502 performs analysis processing for estimating the amount of electric power consumption and the amount of CO2 emission based on the number of printed pages obtained in operation S1306. The content of the processing to be performed in operation S1308 is similar to that in operation S1302, which is described in detail below with reference to FIG. 11.

In operation S1309, the analysis processing unit 502 calculates an estimated amount of CO2 that will be emitted for use a sheet after a print setting is changed (after the change) according to the following formula.

[Estimated amount of CO2 that will be emitted for use of the sheet after the change]=[Actual CO2 emission amount for use of sheets]×[total number of sheets after the change in the column 2004)]/[Total number of actually used sheets]

Based on the above-described calculation, the CO2 emission amount for use of sheets after the setting change may be analyzed by applying the ratio of the total number of actually output sheets obtained from the job history information to the number of sheets to be used according to the changed setting.

In the present exemplary embodiment, in a case where a plurality of types of sheets to be used in a job, it is difficult to identify a sheet on which a concerned page is printed when the print setting is changed to aggregate (Nin1) printing or two-sided printing. Accordingly, in the present exemplary embodiment, for example, if a page printed on a sheet of plain paper and a page printed on a sheet of recycled paper by one-sided printing is changed to two-sided printing, it is useful to calculate the number of sheets after the setting change by counting the plain paper as 0.5 sheet and the recycled paper as 0.5 sheet. In this manner, performing the analysis processing according to the present exemplary embodiment considering the type of each sheet is feasible.

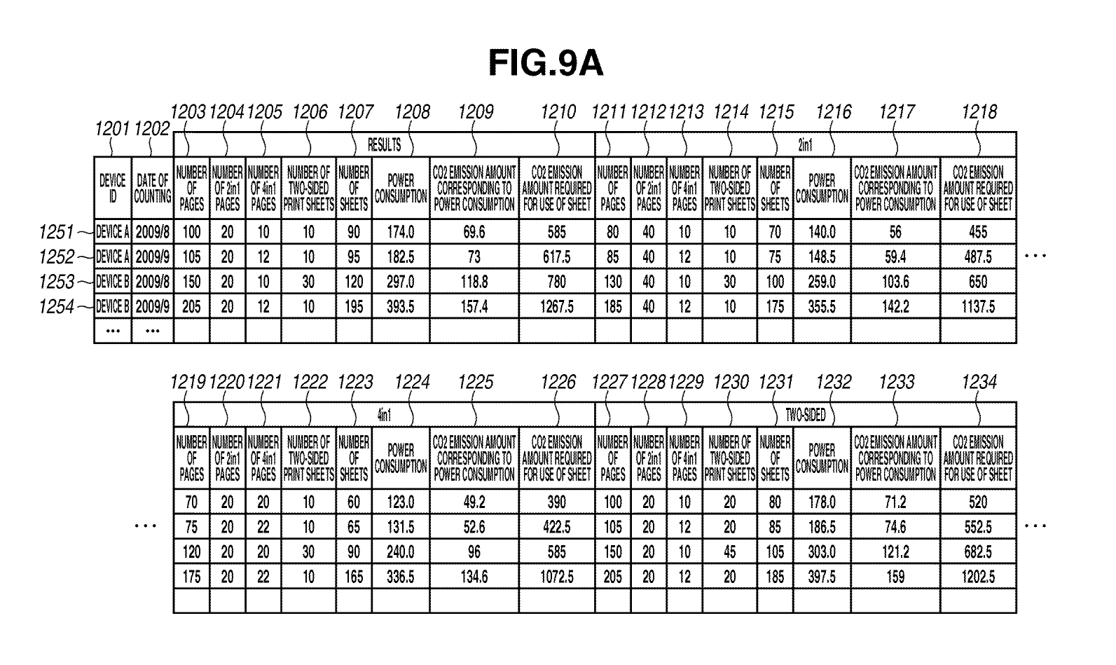

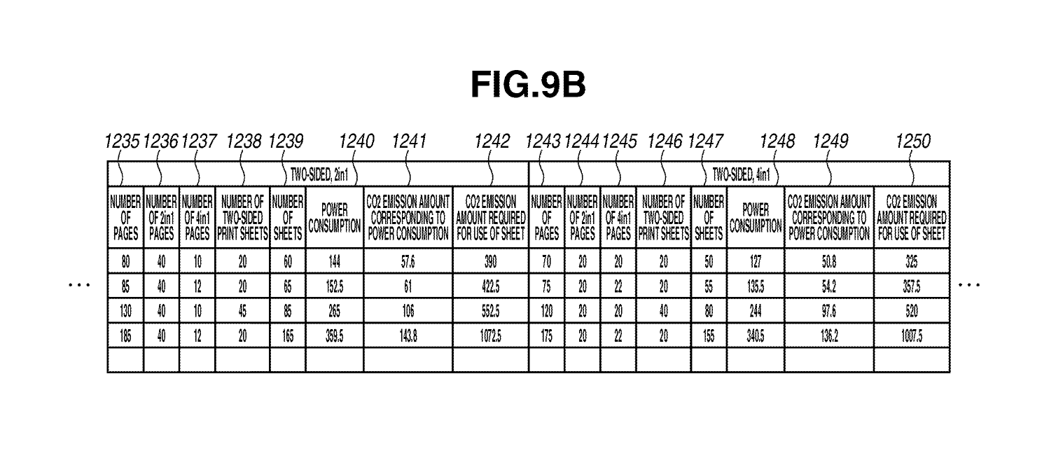

If the repetitive processing in operations S1304 to S1311 has been completed, then in operation S1312, the analysis processing unit 502 stores the calculation results in a summary table (see FIGS. 9A and 9B). The counting results (data in the summary table) are stored in the analysis processing unit 502. The summary table is described in detail below with reference to FIGS. 9A and 9B.

A “device ID” column 1201 stores identification information that may identify each image forming apparatus. The setting information in each row relates to the image forming apparatus identified by the device ID. A “month of counting” column 1202 stores when the date in each row was counted. Each row may be uniquely identified by a combination of the device ID in the column 1201 and the month of counting in the column 1202. In the present exemplary embodiment, the counting is performed for each month. Alternatively, a user may arbitrarily designate the period of counting (year, month, week, etc).

Fields 1203 to 1210 store output results (e.g., number of pages, CO2 emission amount, etc) analyzed from the job history. Fields 1211 to 1218 store estimated values (e.g., number of pages, CO2 emission amount, etc) in a case where 2in1 printing is selected as reduction print setting. Similarly, columns 1219 to 1226, 1227 to 1234, 1235 to 1242, and 1243 to 1250 store estimated values (e.g., number of pages, CO2 emission amount, etc) corresponding to 4in1 printing, two-sided printing, two-sided and 2in1 printing, and two-sided and 4in1 printing, respectively.

The columns 1203, 1211, 1219, 1227, 1235, and 1243 store the total number of pages (number of faces) in the actual results and respective reduction print settings. The columns 1204, 1212, 1220, 1228, 1236, and 1244 store the number of 2in1 printed pages of the total number of pages in the above-described actual results and respective reduction print settings. The columns 1205, 1213, 1221, 1229, 1237, and 1245 store the number of 4in1 printed pages of the total number of pages in the above-described actual results and respective reduction print settings. The columns 1206, 1214, 1222, 1230, 1238, and 1246 store the number of times of the two-sided printing of the total number of pages in the above-described actual results and respective reduction print settings.

The columns 1207, 1215, 1223, 1231, 1239, and 1247 store the total number of sheets to be output in the above-described actual results and respective reduction print settings. The columns 1208, 1216, 1224, 1232, 1240, and 1248 store the power consumption amount in the above-described actual results and respective reduction print settings. In the present exemplary embodiment, the unit [Wh] is used for the power consumption amount. The columns 1209, 1217, 1225, 1233, 1241, and 1249 store the amount of CO2 emission corresponding to the electric power consumption in the above-described actual results and respective reduction print settings. The units [kg] (kilogram) and [lb] (pound) are usable for the CO2 emission amount. In the present exemplary embodiment, the CO2 emission amount is expressed in terms of the unit [kg] (kilogram). The columns 1210, 1218, 1226, 1234, 1242, and 1250 store the amount of CO2 emission due to the use of sheets in the above-described actual results and respective reduction print settings. In general, the units [kg] (kilogram) and [lb] (pound) are usable for the CO2 emission amount. In the present exemplary embodiment, the CO2 emission amount is expressed in terms of the unit [kg] (kilogram).

In operation S1312, the analysis processing unit 502 updates respective values in the row of the “month of counting” column for a corresponding image forming apparatus by adding the values obtained in operation S1302 to operation S1311 (i.e., the number of pages, the number of sheets, the power consumption amount, and the CO2 emission amount in the above-described actual results and respective reduction print settings). The corresponding image forming apparatus represents the row in which the device ID stored in the column 702 of the job history coincides with the device ID stored in the column 1201. The corresponding month of counting represents the row in which a year/month portion of the end time stored in the column 705 of the job history coincides with the month of counting stored in the column 1202. In the present exemplary embodiment, the end time stored in the column 705 is used. The corresponding month of counting may represent the row in which a year/month portion of the start time stored in the column 704 of the job history coincides with the month of counting stored in the column 1202.

For example, according to the job history in the row 711 of the job history information table, the image forming apparatus A (the device A) is stored in the “device ID” column 702, numerical data 2009/9/25 14:40 is stored in the “end time” column 705, and its year/month portion is 2009/9. A row 1252 in FIG. 9A coincides with the row 711, because the row 1252 includes the image forming apparatus A (the device A) in the “device ID” column 1201 and 2009/9 in the “month of counting” column 1202.

When the processing for the acquired unprocessed job history terminates in operation S1313, the analysis processing unit 502 terminates the analysis processing described in the flowchart of FIG. 10.

### [Analysis Processing for Estimating Power Consumption Amount and CO2 Emission Amount for Job]

FIG. 11 is a flowchart illustrating example analysis processing for estimating the amount of electric power consumed and the amount of CO2 emitted for a job. The flowchart in FIG. 11 describes details of the processing to be performed in operation S1302 and operation S1308 illustrated in FIG. 10. If the job power consumption amount and CO2 emission amount analysis processing is called from operation S1302, the analysis processing unit 502 calculates a power consumption amount and a CO2 emission amount corresponding to the power consumption about an actual job processing result based on the job history. On the other hand, if the processing is called from operation S1308, the analysis processing unit 502 calculates a power consumption amount and a CO2 emission amount corresponding to the power consumption when each reduction print setting is applied.

In operation S1401, the analysis processing unit 502 initializes two variables i.e., “power consumption amount for complete one-sided printing (A)” and “power consumption amount for complete two-sided printing (B)”, which are used in the present processing, with zero (0). In the present exemplary embodiment, the “power consumption amount for complete one-sided printing (A)” represents the amount of electric power that will be consumed if all pages included in a job are printed by the one-sided print setting. The “power consumption amount for complete two-sided printing (B)” represents the amount of electric power that will be consumed if all pages included in a job are printed by the two-sided print setting.

In operation S1402, the analysis processing unit 502 calculates the number of two-sided print pages for the job. In the present exemplary embodiment, the recorded job history information includes the number of two-sided print sheets in the column 706. Therefore, the analysis processing unit 502 may calculates the number of two-sided print pages according to the following formula.

Number of two-sided print pages=Number of two-sided print sheets×2

It is however useful to record the job history information including the number of two-sided print pages. When the analysis processing unit 502 calculates a reduced power consumption amount according to each reduction print setting, the number of two-sided print sheets after print setting is changed is stored in the column 2003, i.e., the value obtained in operation S1306, is usable in the calculation.

Subsequently, in operation S1403, the analysis processing unit 502 calculates the number of one-sided print pages according to the following formula.

Number of one-sided print pages=Total number of pages−Number of two-sided print pages

The value obtained in operation S1402 is usable as the number of two-sided print pages. The total number of pages is equal to a sum of values stored in the “number of pages” column 804 of the concerned job row in the printed page information table. For example, the total number of pages of a job having a job history ID “1003” in the column 801 is equal to 15, i.e., a sum of the number of pages in the column 804 in respective rows 815, 816, and 817. It is useful to store the job history information including the number of one-sided print pages. When the analysis processing unit 502 calculates a reduced power consumption amount according to each reduction print setting, the total number of pages is equal to a sum of the number of pages stored in a column 1905 of the whole printed page information of the results calculated in operation S1306.

Next, the analysis processing unit 502 repetitively performs processing of operations S1404 to S1408, with reference to FIG. 7B, for each printed page information of the job history. For example, the analysis processing unit 502 repetitively performs the processing on the data in respective rows 815, 816, and 817 with respect to the job history having the job history ID “1003.” When the analysis processing unit 502 estimates a reduced power consumption amount based on the application of each reduction print setting, the analysis processing unit 502 repetitively performs the processing for each printed page information of the result calculated in operation S1306.

In operation S1405, the analysis processing unit 502 acquires the amount of electric power that will be consumed for one-sided printing and two-sided printing of one page, which relates to the target job history, with reference to the power consumption table illustrated in FIG. 8A. In the present exemplary embodiment, the analysis processing unit 502 acquires the power consumption amount with reference to the job type in the column 703, the page size in the column 803, the color type in the column 802, and the target device, i.e., the device ID in the column 702. When the analysis processing unit 502 estimates a reduced power consumption amount based on the application of each reduction print setting, data in a “page size” column 1904 and a “color type” column 1903 (i.e., the result calculated in operation S1306) is usable in the calculation.

For example, in a case where the job history with the job history ID “1001” is subjected to the processing, the job type is print and the page size is A4. Therefore, the size is “Small” and the color type is “monochrome.” The corresponding power consumption amount in the printing of a one-sided print page is stored in a column 1008. The device ID corresponding to the job history ID “1001” is the image forming apparatus A (the device A). Therefore, the analysis processing unit 502 acquires 1 [Wh] from a corresponding row 1025. Similarly, the power consumption amount in the printing of a two-sided print page is stored in a column 1009. Therefore, the analysis processing unit 502 acquires 1.2[Wh] from the row 1025.

Next, in operation S1406, the analysis processing unit 502 adds a value calculated according to the following formula to the power consumption amount for complete one-sided printing (A).

Power consumption amount for one-sided printing per page×Number of pages

Next, in operation S1407, the analysis processing unit 502 adds a value calculated according to the following formula to the power consumption amount for complete two-sided printing (B).

Power consumption amount for two-sided printing per page×Number of pages

The number of pages in both of operation S1406 and operation S1407 is equal to the value stored in the “number of pages” column 804 of the printed page information table. In the case of calculating the power consumption based on the application of each reduction print setting, the number of pages in the above-described formulae is equal to the value stored in the “number of pages” column 1905 of the print page information, which is the result calculated in operation S1306.

Subsequently, in operation S1409, the analysis processing unit 502 calculates the power consumption amount for the job according to the following formula. In the present exemplary embodiment, the total number of pages is equal to the total number of pages described in operation S1403.

Power consumption amount for job=(Power consumption amount for complete one-sided printing (A)×Number of one-sided print pages+Power consumption amount for complete two-sided printing (B)×Number of two-sided print pages)/Total number of pages

In operation S1410, the analysis processing unit 502 performs power consumption correction processing considering reduced job processing time. First, the analysis processing unit 502 acquires the power consumption amount of the concerned device during job processing from the column 2104, the power consumption amount in the normal mode from the column 2102, and the power consumption amount of in the power saving mode from the column 2103 of the device state power consumption table.

Subsequently, the analysis processing unit 502 calculates an actual job processing time based on the job start time in the column 704 and the job end time in the column 705 according to the following formula.

Actual job processing time=Job end time−Job start time

Subsequently, if the present processing is called from operation S1303 to calculate the power consumption amount as a result of the actual job processing, the analysis processing unit 502 multiplies the actual job processing time by the power consumption amount during the job processing stored in the column 2104 of the concerned device and adds the obtained value to the power consumption amount of the job.

If the present processing is called from operation S1308 to calculate the power consumption amount based on the application of the reduction print setting, the analysis processing unit 502 calculates a reduced job processing time according to the following formula.

Reduced job processing time=(Actual number of large sheet size/monochrome pages−Reduced number of large sheet size/monochrome pages)/Large sheet size/monochrome printing speed in the column 2203+(Actual number of small sheet size/monochrome pages−Reduced number of small sheet size/monochrome pages)/Small sheet size/monochrome printing speed in the column 2202+(Actual number of large sheet size/color pages−Reduced number of large sheet size/color pages)/Large sheet size/color printing speed in the column 2205+(Actual number of small sheet size/color pages−Reduced number of small sheet size/color pages)/Small sheet size/color printing speed in the column 2204

To perform the above-described calculation, the analysis processing unit 502 acquires printing speed data (in the columns 2202 to 2205) from the row of the corresponding device ID in the column 2201 of the device information table. Further, the analysis processing unit 502 acquires each number of pages from the printed page information table or from a printed page information table applicable to a change of aggregate setting. Further, the analysis processing unit 502 regards the paper size equal to or greater than B4 as “Large” and the paper size smaller than B4 as “Small” in the above-described calculations.

Further, the analysis processing unit 502 adds a power consumption amount obtained according to the following formula to the power consumption amount of the job.

(Actual job processing time−Reduced job processing time)×Power consumption amount during job processing

Thus, when a reduction print setting is applied, the job processing time may be reduced according to a reduction in the number of printed pages. In this manner, the reduction in power consumption is taken into consideration in the present exemplary embodiment.

In operation S1411, the analysis processing unit 502 calculates a CO2 emission amount for the job based on the power consumption amount for the job. Although not illustrated, the analysis processing unit 502 stores a CO2 emission rate [kg/Wh] and calculates a CO2 emission amount relating to the job processing according to the following formula.

CO2 emission amount for job=Power consumption amount of job×CO2 emission rate

When the processing of the flowchart illustrated in FIG. 11 terminates, the analysis processing unit 502 resumes the processing illustrated in FIG. 10.

### [Analysis Processing for Estimating CO2 Emission Amount Due to Use of Sheets in Job]

FIG. 12 illustrates a detailed processing procedure of the sheet originated CO2 emission amount analysis processing (step S1303).

In operation S1501, the analysis processing unit 502 initializes a variable “sheet CO2 emission amount” with zero (0). Subsequently, the analysis processing unit 502 repetitively performs sequential processing in operations S1502 to S1505 for each sheet information of the target job history. For example, if a target job history has a job history ID “1003”, the analysis processing unit 502 performs the following processing on data stored in the rows 914, 915, and 916, which have the job history ID “1003” in the column 901 of the job history sheet information table.

In operation S1503, the analysis processing unit 502 acquires a CO2 emission amount that corresponds to the sheet type in the column 902 and the sheet size in the column 903 of the target job history from the sheet CO2 emission amount table (see FIG. 8B). For example, according to the sheet information in the row 914, the sheet type in the column 902 is recycled paper and the sheet size in the column 903 is A4. The corresponding CO2 emission amount is 6 [g] stored in a row 1112 of the sheet CO2 emission amount table in FIG. 8B. In operation S1504, the analysis processing unit 502 adds a value obtained according to the following formula to the variable “sheet CO2 emission amount.”

Number of sheets×CO2 emission amount corresponding to concerned sheet size/sheet type

For example, according to the sheet information in the row 914, the number of sheets in the column 904 is 6 sheets and the CO2 emission amount corresponding to the sheet size/sheet type is 6 [g]. Therefore, the analysis processing unit 502 adds a numerical value “36” (=6×6) to the variable “sheet CO2 emission amount.” If the repetitive processing terminates at operation S1505, the analysis processing unit 502 terminates the sheet originated CO2 emission amount analysis processing and resumes the processing illustrated in FIG. 10.
[Analysis Processing for Estimating Number of Pages and Number of Sheets after Print Setting Change]

FIG. 13 is a flowchart illustrating details of processing (step S1306) for estimating the number of pages and the number of sheets after the print setting change.

In operation S1601, the analysis processing unit 502 acquires printed page information of a target job history with reference to the printed page information table (see FIG. 7B). The analysis processing unit 502 acquires a row having a job history ID in the column 801 in the printed page information table that coincides with the job history ID in the column 701 of the target job history. In operation S1602, the analysis processing unit 502 divides the number of pages in the column 804 of each row included in the printed page information acquired in operation S1601 by the number of copies in the column 708 of the job history.

In operation S1603, the analysis processing unit 502 determines whether there is not any printed page information that leaves a remainder when the number of pages is divided by the number of copies as the calculation result in operation S1602. If it is determined that the printed page information leaves no remainder (YES in operation S1603), the analysis processing unit 502 determines that the result is normal and then advances the processing to operation S1604. If it is determined that the printed page information leaves a remainder (NO in operation S1603), the analysis processing unit 502 determines that the result is abnormal. Then, the analysis processing unit 502 terminates the processing illustrated in FIG. 13 and resumes the processing illustrated in FIG. 10. In a case where the printed page information leaves a remainder, it is presumed that the job has been interrupted in midstream or the job has been restarted from a previously interrupted position. In the present analysis processing, the analysis processing unit 502 disregards the result relating to the above-described processing.

In operation S1604, the analysis processing unit 502 classifies the printed page information into a plurality of groups according to the page size in the column 803. For example, if the job history ID of a target job history is “1003”, the analysis processing unit 502 makes a group including rows 815 and 816 which have the same page size “A4” in the column 803 and a group including only one row 817 having the page size “A3.”

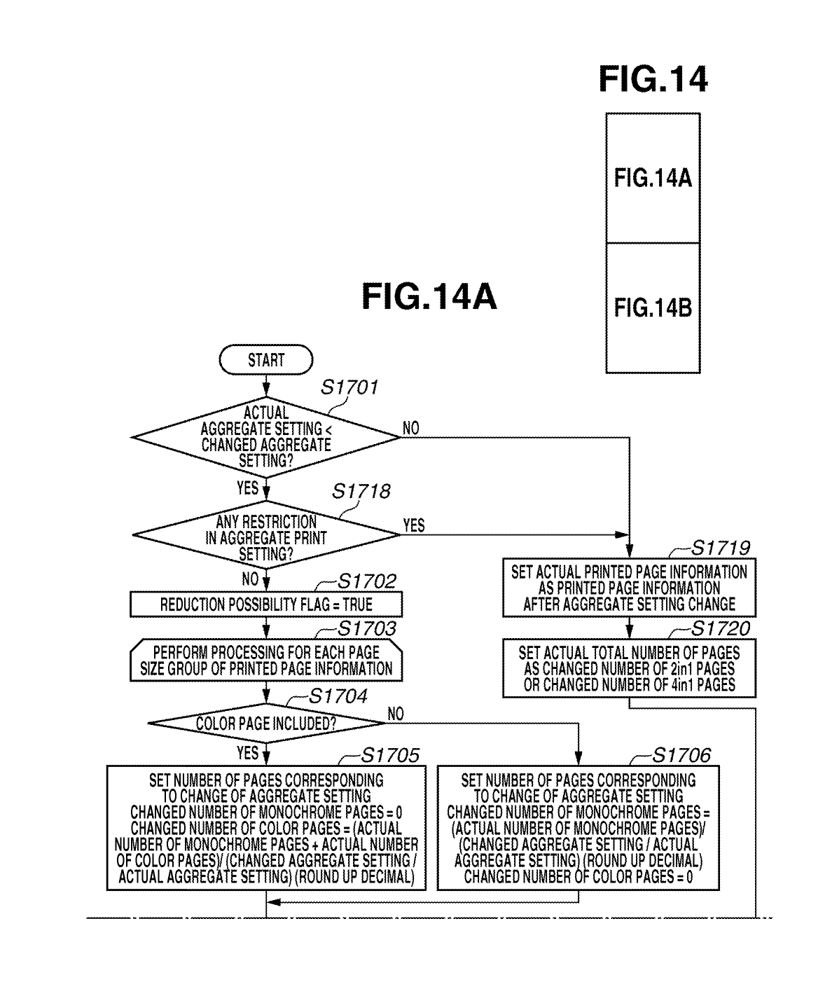

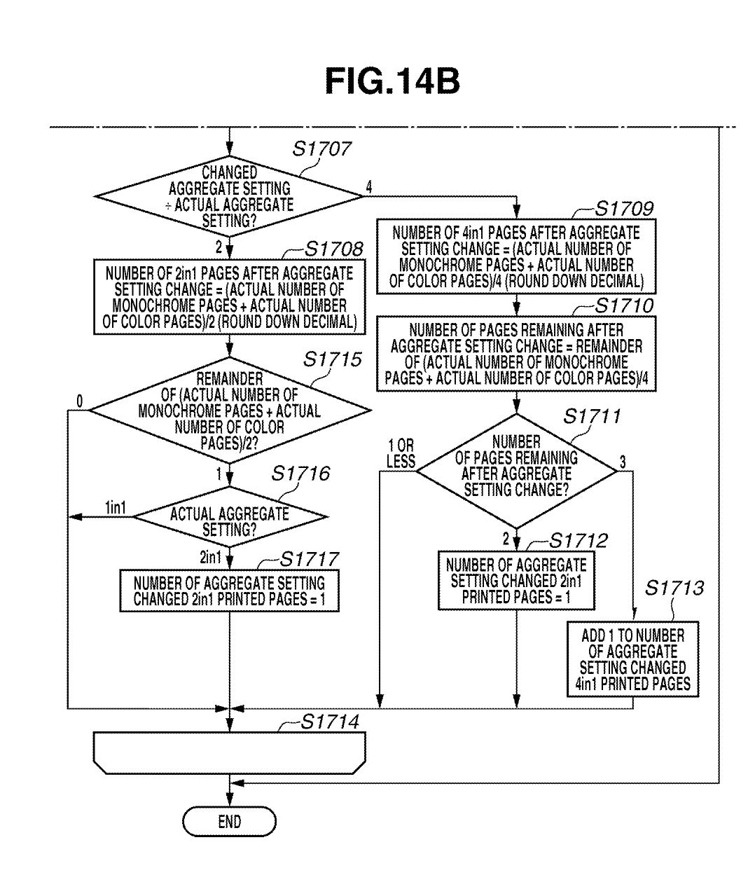

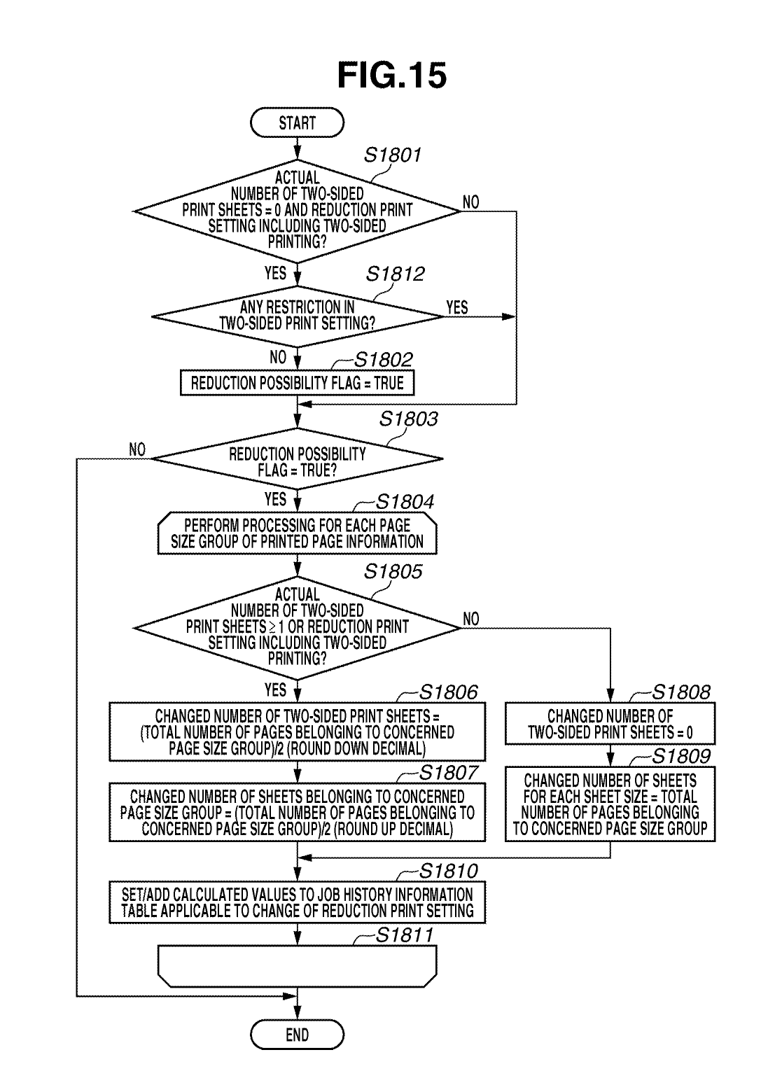

In operation S1605, the analysis processing unit 502 performs calculation processing for estimating the number of pages corresponding to a change of the aggregate print setting. The calculation processing to be performed in operation S1605 is described in detail below with reference to FIG. 14. Further, in operation S1606, the analysis processing unit 502 performs calculation processing for estimating the number of sheets and the number of two-sided print sheets corresponding to a change of the two-sided print setting. The calculation processing to be performed in operation S1606 is described in detail below with reference to FIG. 15.

In operation S1607, the analysis processing unit 502 multiplies the number of pages in the column 1905, the number of 2 in1 pages in the column 1906, the number of 4 in1 pages in the column 1907, the number of sheets, and number of two-sided print sheets after the reduction print setting is changed by the number of copies in the column 708. Through the above-described processing, the analysis processing unit 502 may obtain the number of pages, the number of sheets, and the number of two-sided print sheets required for the entire job after the reduction print setting is changed. Subsequently, the analysis processing unit 502 resumes the processing illustrated in FIG. 10.

### [Calculation Processing for Estimating Number of Pages According to Aggregate Print Setting Change]

FIG. 14 (including FIG. 14A and FIG. 14B) is a flowchart illustrating a detailed processing procedure of number of pages calculation processing according to the aggregate print setting change (step S1605).

In operation S1701, the analysis processing unit 502 determines whether the actual aggregate setting in the column 707 recorded in the job history is smaller than the aggregate setting of the reduction print setting (designated in operation S1304). If it is determined that the actual aggregate setting is smaller than the aggregate setting of the reduction print setting (YES in operation S1701), the processing proceeds to operation S1718. If it is determined that the actual aggregate setting is not smaller than the aggregate setting of the reduction print setting (NO in operation S1701), the processing proceeds to operation S1719.

In operation S1718, the analysis processing unit 502 determines whether there is any restriction in the aggregate print setting. If it is determined that there is not any restriction (NO in operation S1718), the processing proceeds to operation S1702. If it is determined that there is at least one restriction (YES in operation S1718), the processing proceeds to operation S1719. The restriction of the aggregate print setting is performed in the following manner.

The analysis processing unit 502 acquires information about the change to aggregate print setting in the column 2403 in the row that coincides with the final extension of a document name in the column 709 of the target job history with reference to an application type oriented print setting table (see FIG. 19A). The analysis processing unit 502 compares the aggregate print setting change with the reduction print setting to determine the presence of any restriction. If a comparison result remains within a restriction range, the analysis processing unit 502 determines that there is not any restriction with respect to the application type.

Further, the analysis processing unit 502 acquires information about the change to aggregate print setting in the column 2403 in the row that coincides with the management code in the column 710 of the target job history with reference to a management code oriented print setting table (see FIG. 19B). The analysis processing unit 502 compares the aggregate print setting change with the reduction print setting to determine the presence of any restriction. If a comparison result remains within a restriction range, the analysis processing unit 502 determines that there is not any restriction with respect to the management code. If there is not any restriction with respect to both of the application type and the management code, the analysis processing unit 502 finally confirms no restrictions in operation S1718.

In operation S1702, the analysis processing unit 502 initializes the variable “reduction possibility flag” to TRUE. The analysis processing unit 502 repeats processing in operations S1703 to S1714 for each page size group of the printed page information classified in operation S1604. If the processing in operations S1703 to S1714 has been completed, the analysis processing unit 502 terminates the processing illustrated in FIG. 14 and resumes the processing illustrated in FIG. 13.

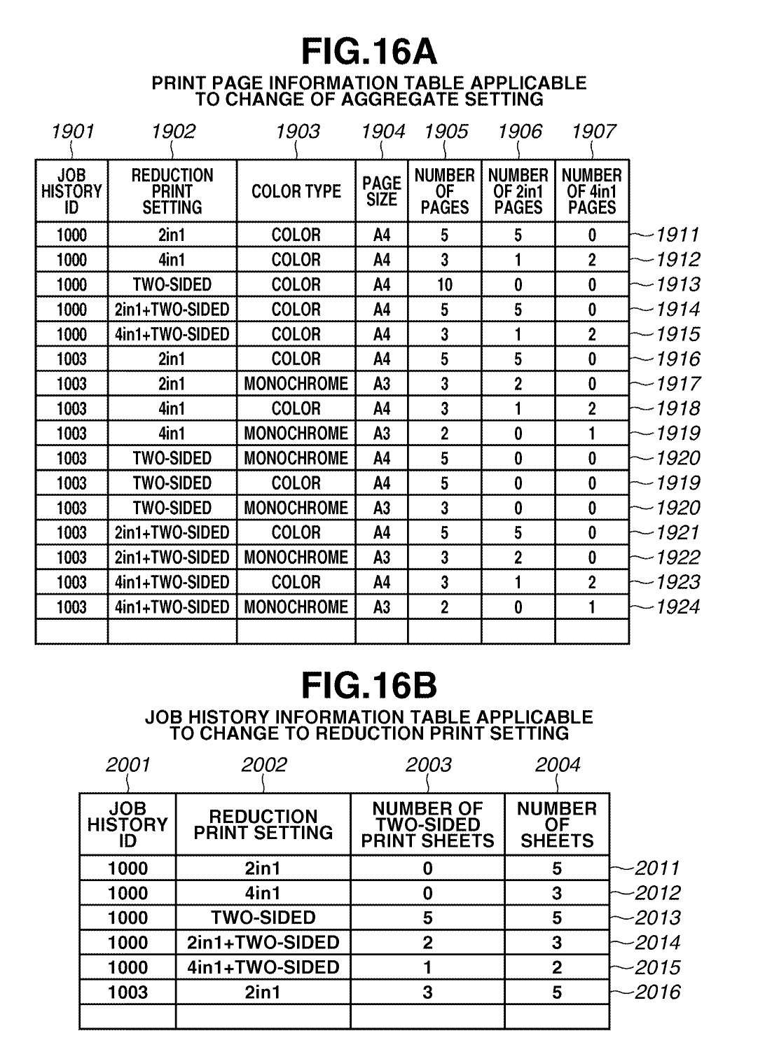

The analysis processing unit 502 stores the number of pages after the reduction print setting is changed in the printed page information table applicable to a change of the aggregate setting change (see FIG. 16A), and manages the stored information. The printed page information table illustrated in FIG. 16A includes a column 1901 that stores job history ID, which corresponds to the information stored in the “job history ID” column 801. A column 1902 stores the reduction print setting designated in operation S1304. The column 1903 stores the color type of a reduction print setting changed printed page. The column 1904 stores the page size of the reduction print setting changed printed page designated in operation S1703. The columns 1905, 1906, and 1907 store the number of pages, the number of 2in1 pages, and the number of 4in1 pages having the color type stored in the column 1903 and the page size stored in the column 1904 in a case where the job history designated by the job history ID stored in the column 1901 is changed to the reduction print setting stored in the column 1902.

For example, according to the printed page information stored in a row 1911, the job history ID is 1000 and 2in1 is designated as the reduction print setting of the job history. Further, according to the printed page information, the color type in the column 1903 is color, the page size in the column 1904 is A4, and the number of pages in the column 1905 is five. Out of five pages, the number of 2in1 pages in the column 1906 is five, and the number of 4in1 pages in the column 1907 is zero.

In operation S1704, the analysis processing unit 502 determines whether printed page information having a color type “color” in the column 802 is included in the printed page information group. If it is determined that the printed page information having the color type “color” is present (YES in operation S1704), the processing proceeds to operation S1705. If it is determined that the printed page information having the color type “color” is not present (NO in operation S1704), the processing proceeds to operation S1706. For example, when the job history has the job history ID “1003”, the group having the page size “A4” has the color type “color” stored in the row 816. Therefore, the analysis processing unit 502 determines that the “A4” group includes “color.”

In operation S1705, the analysis processing unit 502 adds the following printed page information that corresponds to a change of the aggregate setting.

Changed page size in the column 1904=Page size of page size group

Changed color type in the column 1903=Color

Changed number of pages in the column 1905=(Total number of pages of page size group in the column 804)/(Changed aggregate setting/Actual aggregate setting)(round up decimal)

Further, as example processing in operation S1705 according to another exemplary embodiment, the analysis processing unit 502 may add the following aggregate setting changed printed page information if there is printed page information including a “monochrome” color type.

Changed page size in the column 1904=Page size of page size group

Changed color type in the column 1903=Monochrome

Changed number of pages in the column 1905=(Color type=number of monochrome pages in the column 804)/(Changed aggregate setting/Actual aggregate setting)(round down remainder)

Further, the analysis processing unit 502 adds the following aggregate setting changed printed page information.

Changed page size in the column 1904=Page size of page size group

Changed color type in the column 1903=Color

Changed number of pages in the column 1905=(Number of color type “Color” pages in the column 804)+(Remainder of (Number of color type “Monochrome” pages in the column 804)/(Changed aggregate setting/Actual aggregate setting))/(Changed aggregate setting/Actual aggregate setting)(round up decimal)

Through the above-described processing, it becomes feasible to perform calculations in such a way as to perform printing by aggregate setting exclusively for monochrome pages and separately perform an aggregate print for the remaining color pages.

In operation S1706, the analysis processing unit 502 adds the following printed page information that corresponds to a change of the aggregate setting.

Changed page size in the column 1904=Page size of page size group

Changed color type in the column 1903=Monochrome

Changed number of pages in the column 1905=(total number of pages in the column 804 of page size group)/(Changed aggregate setting/Actual aggregate setting)(round up decimal)

According to the processing in operation S1704 to operation S1706, if at least one color page is included in the same page size group, a group including only the color pages may be obtained after the aggregate setting is changed. If the same page size group includes only the monochrome pages, the analysis processing unit 502 calculates the aggregate setting changed values while regarding all the pages as monochrome pages.

Further, the analysis processing unit 502 divides the total number of pages having the same page size by a value obtained by dividing the aggregate setting of the reduction print setting by the actual aggregate setting recorded in the job history. The analysis processing unit 502 obtains the changed number of pages by rounding the obtained value up to the nearest whole number. If the recorded actual setting is 2in1 and the reduction print setting is 4in1, the analysis processing unit 502 divides the total number of pages by 2 (=4=2). According to the above-described processing, changing a 2in1 job to a 4in1 job and changing a 1 in1 job to a 2in1 job are processed similarly.

In operation S1707, the analysis processing unit 502 checks contents of the aggregate setting changed to the reduction print setting. If it is determined that the reduction print setting is 2in1 (2 in operation S1707), the processing proceeds to operation S1708. If it is determined that the reduction print setting is 4in1 (4 in operation S1707), the processing proceeds to operation S1709.

In operation S1708, the analysis processing unit 502 calculates the number of pages to be printed when 2in1 is applied as the changed aggregate setting according to the following formula.

Number of 2 in1 pages in the column 1906 after aggregate setting change=(Actual number of monochrome pages+Actual number of color pages)/2(round down decimal)

In operation S1715, the analysis processing unit 502 checks the remainder left in the calculation of (Actual number of monochrome pages+Actual number of color pages)/2. If it is determined that the remainder is 1 (1 in operation S1715), the processing proceeds to operation S1716. If it is determined that the remainder is 0 (0 in operation S1715), the processing proceeds to operation S1714. In operation S1716, the analysis processing unit 502 checks the actual aggregate setting recorded in the job history. If it is determined that the actual aggregate setting is 2in1 (2in1 in operation S1716), the processing proceeds to operation S1717. If it is determined that the actual aggregate setting is 1in1 (1in1 in operation S1716), the processing proceeds to operation S1714. In operation S1717, the analysis processing unit 502 sets the number of 2in1 printed pages after aggregate setting change to 1.

In operation S1709, the analysis processing unit 502 calculates the number of pages to be printed when 4in1 is applied as the changed aggregate setting according to the following formula.

Number of 4 in1 pages in the column 1907 after aggregate setting change=(Actual number of monochrome pages+Actual number of color pages)/4(round down decimal)

Subsequently, in operation S1710, the analysis processing unit 502 calculates the number of pages remaining after the aggregate setting change according to the following formula.

Number of pages remaining after aggregate setting change=Remainder of (Actual number of monochrome pages+Actual number of color pages)/4

In operation S1711, the analysis processing unit 502 checks the number of pages remaining after the aggregate setting change. If it is determined that the number of the remaining pages is equal to or less than 1 (1 or less in operation S1711), the processing proceeds to operation S1714. The analysis processing unit 502 terminates the processing for the concerned page size group. If it is determined that the number of the remaining pages is 2 (2 in operation S1711), the processing proceeds to operation S1712. If it is determined that the number of the remaining pages is 3 (3 in operation S1711), the processing proceeds to operation S1713. In operation S1712, the analysis processing unit 502 sets the number of 2in1 printed pages in the column 1906 after aggregate setting changed to 1. In operation S1713, the analysis processing unit 502 adds 1 to the number of 4 in1 pages in the column 1907 after aggregate setting change.

According to the aggregate setting of the reduction print setting in operation S1719 and operation S1720, the number of pages for the concerned job remains unchanged. Therefore, the analysis processing unit 502 performs setting in such a way as to equalize each changed number of pages information with the results recorded in the job history. In operation S1719, the analysis processing unit 502 sets the actual printed page information recorded in the job history as the number of printed pages information after the aggregate setting change. The analysis processing unit 502 copies the color type stored in the column 802 to the column 1903, the page size stored in the column 803 to the column 1904, and the number of pages stored in the column 804 to the column 1905. In operation S1720, the analysis processing unit 502 sets the total number of pages in the column 804 of the printed page information table as changed number of 2 in1 pages in the column 1906 or changed number of 4 in1 pages in the column 1907.

### [Calculation Processing for Estimating Number of Pages According to Two-Sided Print Setting Change]

FIG. 15 is a flowchart illustrating a detailed processing procedure of processing for calculating the number of sheets and the number of two-sided print sheets according to the two-sided print setting change (step S1606).

In operation S1801, the analysis processing unit 502 determines whether the number of two-sided print sheets in the column 706 of the job history is zero (=0) and the reduction print setting includes two-sided printing. If the determination result is true (YES in operation S1801), the processing proceeds to operation S1812. If the determination result is false (NO in operation S1801), the processing proceeds to operation S1803. In other words, the analysis processing unit 502 checks if the two-sided setting is effective to realize the reduction.

In operation S1812, the analysis processing unit 502 determines whether there is any restriction in the two-sided print setting. If it is determined that there is no restriction (NO in operation S1812), the processing proceeds to operation S1802. If it is determined that at least one restriction is present (YES in operation S1812), the processing proceeds to operation S1803. The analysis processing unit 502 performs following processing with respect to the restriction of the two-sided print setting.

The analysis processing unit 502 acquires information about the change to two-sided printing in the column 2303 in the row that coincides with the final extension of a document name in the column 709 of the target job history with reference to the application type oriented print setting table (see FIG. 19A). Then, the analysis processing unit 502 compares the two-sided print setting change information with the reduction print setting to identify the presence of any restriction. If a comparison result remains within a restriction range, the analysis processing unit 502 determines that there is not any restriction with respect to the application type.

Further, the analysis processing unit 502 acquires information about the change to two-sided printing in the column 2402 in the row that coincides with the management code in the column 710 of the target job history with reference to the management code oriented print setting table (see FIG. 19B). Then, the analysis processing unit 502 compares the two-sided print setting change information with the reduction print setting to identify the presence of any restriction. If a comparison result remains within a restriction range, the analysis processing unit 502 determines that there is not any restriction with respect to the management code. If there is not any restriction with respect to both of the application type and the management code, the analysis processing unit 502 finally confirms no restrictions in operation S1812.

In operation S1802, the analysis processing unit 502 sets the variable “reduction possibility flag” to TRUE. In operation S1803, the analysis processing unit 502 determines whether the variable “reduction possibility flag” is TRUE. If it is determined that the variable “reduction possibility flag” is TRUE (YES in operation S1803), the processing proceeds to operation S1804. If it is determined that the reduction possibility flag is not TRUE (NO in operation S1803), the analysis processing unit 502 terminates the processing illustrated in FIG. 15 and resumes the processing illustrated in FIG. 13. In other words, when the two-sided setting is not effective to realize the reduction and when the number of pages has been already calculated in the number of pages calculation processing according to the aggregate setting change, the analysis processing unit 502 performs the processing in operation S1804 and subsequent steps.

In the following processing, the analysis processing unit 502 stores the number of sheets and the number of two-sided print sheets after changing to the reduction print setting in the job history information table (see FIG. 16B), and manages the stored information. A column 2001 stores job history ID that corresponds to the job history ID in the column 801. A column 2002 stores the reduction print setting designated in operation S1304. A column 2003 stores the number of two-sided print sheets and a column 2004 stores the number of sheets, which indicate the number of two-sided print sheets and the number of sheets corresponding to each reduction print setting of each job history.

Subsequently, the analysis processing unit 502 repetitively performs sequential processing in operation S1804 to operation S1811 for each page size group with reference to the printed page information (see FIG. 16A).

In operation S1805, the analysis processing unit 502 determines whether the number of two-sided print sheets in the column 706 recorded as a result in the target job history is equal to or greater than 1 or the reduction print setting includes two-sided printing. If the determination result is true (YES in operation S1805), the processing proceeds to operation S1806. If the determination result is false (NO in operation S1805), the processing proceeds to operation S1808.

In operation S1806, the analysis processing unit 502 calculates the number of two-sided print sheets after the reduction print setting change for the concerned page size group according to the following formula.

Changed number of two-sided print sheets=(Total number of pages in the column 1905 for concerned page size group)/2(round down decimal)

In operation S1807, the analysis processing unit 502 calculates the number of sheets after the reduction print setting change for the concerned page size group according to the following formula.

Changed number of sheets=(Total number of pages in the column 1905 for concerned page size group)/2(round up decimal)

In operation S1808, the analysis processing unit 502 sets the number of two-sided print sheets after the reduction print setting change to zero. In operation S1809, the analysis processing unit 502 sets the total number of pages in the column 1905 for the concerned page size group as the number of sheets for each sheet size after the reduction print setting change.

In operation S1809, the analysis processing unit 502 sets or adds calculated values to the reduction print setting changed job history information table. If the processing is initially performed for the concerned job history, the analysis processing unit 502 adds a new row to the table. The analysis processing unit 502 sets the job history ID in the column 2001 and the reduction print setting in the column 2002. Further, the analysis processing unit 502 sets the calculated number of two-sided print sheets in the column 2003 and the number of sheets in the column 2004. If the processing is previously performed at least one time for the concerned job history, the analysis processing unit 502 adds the number of two-sided print sheets in the column 2003 and the number of sheets in the column 2004. When the above-described processing is completed, the analysis processing unit 502 resumes the processing illustrated in FIG. 13.

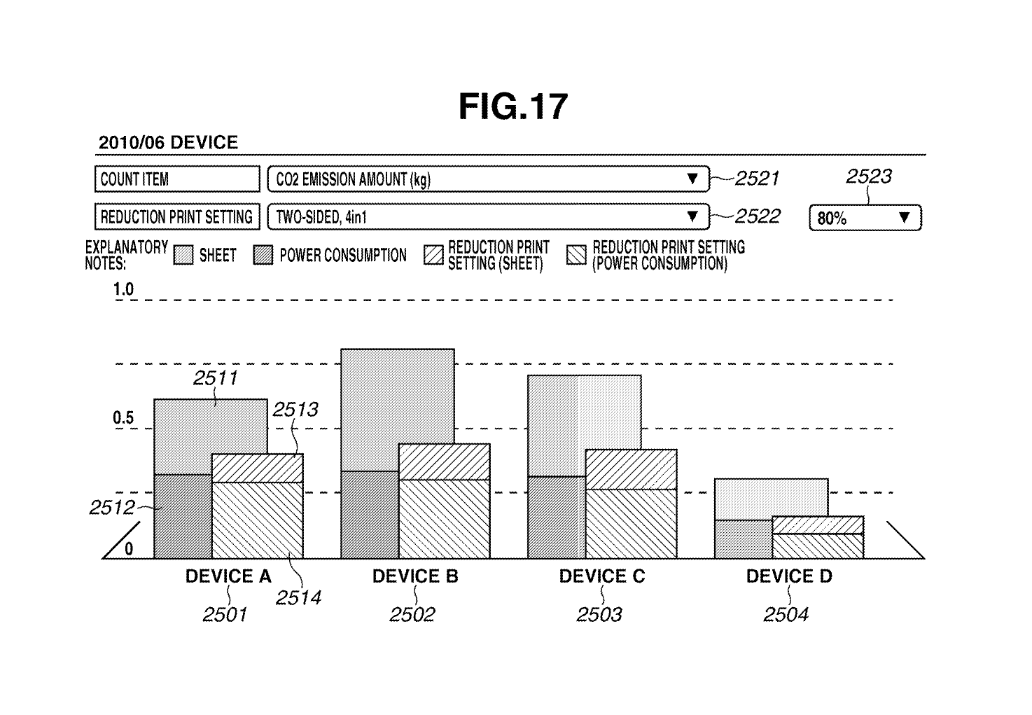

An example of a display screen that indicates analysis results about the power consumption amount and the CO2 emission amount is described below with reference to FIG. 17. The web browser 404 of the host computer 101 accesses the interface unit 501 of the analysis server 104 to transmit a request to acquire counting result display data. In response to the request, the interface unit 501 acquires counting results from the analysis processing unit 502 and generates display data having a format (e.g., HTML) displayable on the web browser 404.

The interface unit 501 transmits the generated HTML display data to the web browser 404. The web browser 404 interprets the received display data and displays the counting results on the display device 210. FIG. 17 illustrates example contents displayed on the display device 210 by the web browser 404.

The display contents include the following items. A count item 2521 is a drop-down list that enables a user to select one of a plurality of count items including the CO2 emission amount, the power consumption, and the number of printed pages. A reduction print setting item 2522 is a drop-down list that enables a user to select one of a plurality of reduction print settings, including “2in1”, “4in1”, “two-sided”, “two-sided and 2in1”, and “two-sided and 4in1.”

A control 2523 enables a user to designate an application rate of the reduction print setting. For example, if the reduction print setting is “two-sided”, the application rate of the reduction print setting may be set to an arbitrary value between the actual application rate (=actual number of two-sided print pages in the column 1206/number of pages in the column 1203) to the maximum application rate (=number of two-sided print pages in the column 1230/number of pages in the column 1227 corresponding to two-sided reduction print setting). More specifically, when the reduction print setting of the image forming apparatus A (the device A) at the month of counting “2009/8” is “two-sided”, the application rate of the reduction print setting may be designated in a range from 10% (=10/100) to 20% (=20/100).

Even when it is tried to apply the two-sided setting to all print processing as much as possible, the two-sided printing may not be applied to some of the pages. For example, if the total number of pages included in a job is an odd number, the final page will be output as a one-sided print product even when the two-sided printing is applied to the entire job. Further, the printing according to the two-sided setting may be already performed as a result. Accordingly, in almost all cases, it is rare that the application rate of the two-sided printing is equal to 100%. Further, some documents e.g., official documents officially require a one-sided print product.

Accordingly, in the present exemplary embodiment, the application rate of the reduction print setting may be arbitrarily designated and the analysis may be performed based on the designated application rate. According to the present exemplary embodiment, each user may identify an appropriate application rate of the reduction print setting to attain a target level in the power saving amount and in the reduction of the CO2 emission amount.

Similarly, the analysis processing unit 502 calculates a range of the application rate that may be designated for the 2in1 setting.

Actual application rate=Actual number of 2 in1 pages in the column 1204/Number of pages in the column 1203

Maximum application rate=Number of 2 in1 pages in the column 1212 corresponding to 2in1 reduction print setting/Number of pages in the column 1211

The analysis processing unit 502 calculates a range of the application rate that may be designated for 4in1 setting by regarding a half of the 2 in1 pages as the number of 4 in1 pages.

Actual application rate=Actual ((Number of 2 in1 pages in the column 1204/2)+Number of 4 in1 pages in the column 1205)/Number of pages in the column 1203

Maximum application rate=((Number of 2 in1 pages in the column 1220/2)+Number of 4 in1 pages in the column 1221) corresponding to 2in1 reduction print setting/Number of pages in the column 1219

When the reduction print setting is “two-sided and 2in1”, the analysis processing unit 502 independently calculates an actual application rate and a maximum application rate for each of the two-sided setting and the 2in1 setting, as described above. Then, the analysis processing unit 502 sets squares of the obtained values as an actual application rate and a maximum application rate for the “two-sided and 2in1” setting. The analysis processing unit 502 performs similar processing for the “two-sided and 4in1” setting.

The analysis processing unit 502 acquires counting results corresponding to the contents selected in the count item 2521 and the reduction print setting item 2522 from the summary table (see FIG. 9) and displays the acquired counting results on the display device. According to the example illustrated in FIG. 17, “CO2 emission amount” is selected as the count item and “two-sided and 4in1” is selected as the reduction print setting. Therefore, the analysis processing unit 502 acquires the CO2 emission amount in the column 1209 corresponding to the power consumption amount and the CO2 emission amount in the column 1210 due to use of sheets as actual results, as well as the CO2 emission amount in the column 1249 corresponding to the power consumption amount and the CO2 emission amount in the column 1250 due to the use of sheets in the case of “two-sided and 4in1” reduction print setting. In FIG. 17, a set of counting results 2511, 2512, 2513, and 2514 corresponds to the image forming apparatus A (the device A) in the column 2501.

The counting result 2511 represents the actual CO2 emission amount due to use of sheets, which may be displayed based on the CO2 emission amount in the column 1210 due to the used of sheets by the image forming apparatus A (the device A). The counting result 2512 represents the CO2 emission amount corresponding to the actual power consumption, which may be displayed based on the CO2 emission amount in the column 1209 corresponding to the electric power consumed by the image forming apparatus A (the device A).

The counting result 2513 represents the CO2 emission amount due to use of sheets in the case of changing to the reduction print setting, which may be displayed based on the CO2 emission amount in the column 1250 due to use of sheets by the image forming apparatus A (the device A). The counting result 2514 represents the CO2 emission amount corresponding to the power consumption in the case of changing to the reduction print setting, which may be displayed based on the CO2 emission amount in the column 1249 corresponding to the electric power consumed by the image forming apparatus A (the device A). Similarly, FIG. 17 illustrates counting results of the device B in the column 2502, the device C in the column 2503, and the device D in the column 2504.

If the application rate is not the maximum application rate, the analysis processing unit 502 calculates counting results when the reduction print setting is changed according to the following formula.

Reduction print setting changed value at designated application rate=Actual value−(Actual value−Reduction print setting changed value)/((Designated application rate/(Actual application rate−Maximum application rate))

As illustrated in FIG. 17, when a format used for the display enables a user to compare the counting results based on the recorded information with the analysis results based on a change of the reduction print setting, and further when itemized contents of the CO2 emission amount are displayed for each factor, the user may check the status in detail. Further, when the screen display may be switched by selecting a desired count item between the CO2 emission amount, the number of pages, and the number of sheets, it becomes feasible to confirm reduction effects obtainable when the reduction print setting is changed not only for one item but also for other various items.

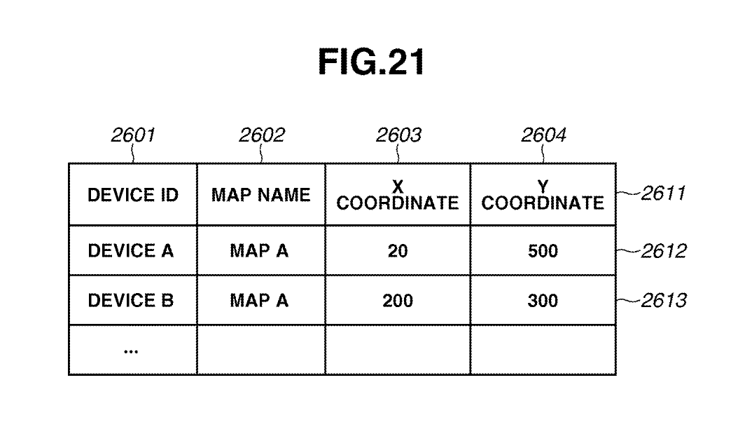

FIG. 21 illustrates an example of a device map information table according to a second exemplary embodiment. The device map illustrates the setup location of each device on a map (e.g., in an office). A column 2601 stores device ID information that may identify each image forming apparatus. Setting data in each row relates to an image forming apparatus that may be identified by the device ID. A column 2602 stores map name information that designates a name of a map on which the image forming apparatus of the concerned row is registered.

Although not illustrated, the map image may be separately registered in the analysis server. A column 2603 stores X-coordinate value and a column 2604 stores Y-coordinate value. Two-dimensional position defined by the X- and Y-coordinate values stored in the columns 2603 and 2604 represents the setup location of the image forming apparatus of the concerned row on the map, which may be designated by the map name in the column 2602. In the present exemplary embodiment, X coordinate=0 and Y coordinate=0 represent the upper left point of the map.

### <CO2 Emission Amount Map and Drill Down>

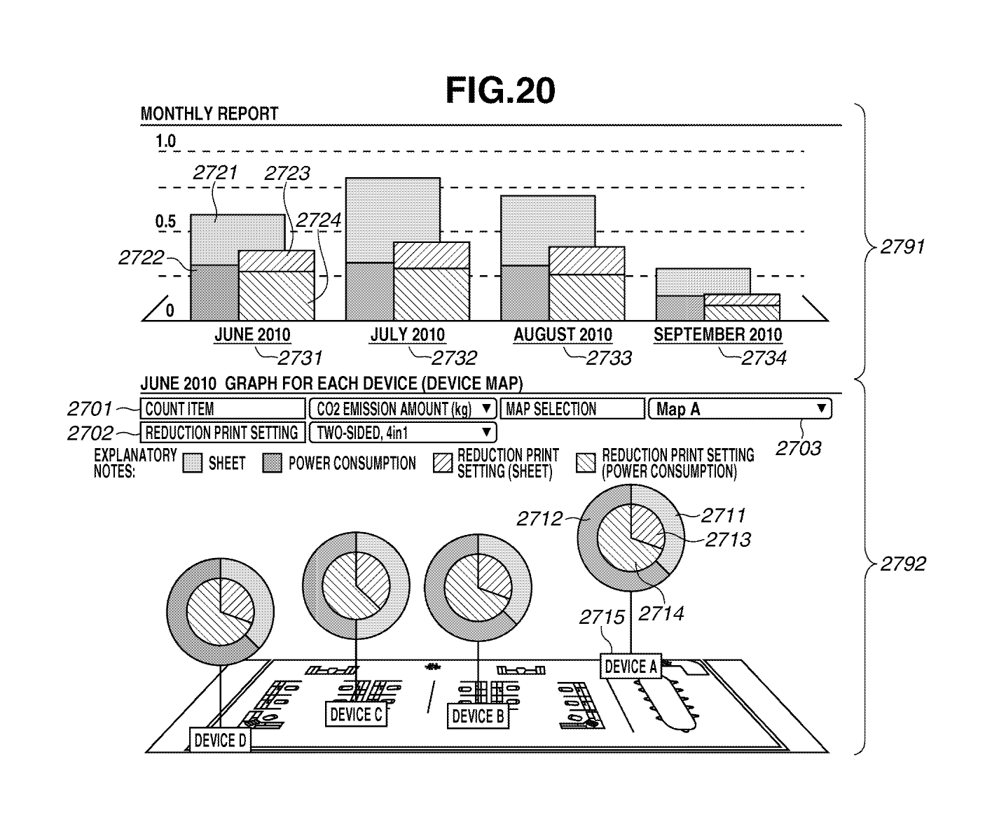

FIG. 20 illustrates an example of a display screen that indicates analysis results about the power consumption amount and the CO2 emission amount. Similar to the display screen illustrated in FIG. 17, the web browser 404 of the host computer 101 accesses the analysis server 104 to transmit a request to acquire counting results and map information. The analysis server 104 generates display data having a format (e.g., HTML, image file, etc) displayable on the web browser 404 and transmits the generated display data to the web browser 404. The web browser 404 interprets the received display data and displays the counting results on the display device 210. FIG. 20 illustrates example contents displayed on the display device 210 by the web browser 404.

The display screen illustrated in FIG. 20 includes two, upper and lower, graph regions. The upper part 2791 displays a graph illustrating counting results of each month. The lower part 2792 displays a device map graph.

Display contents of the counting results may be set by selecting from a count item 2701 and a reduction print setting item 2702, provided at a central portion of the display screen. In this respect, the items 2701 and 2702 are similar to the items 2521 and 2522 illustrated in FIG. 17. According to the example illustrated in FIG. 20, “CO2 emission amount” is selected as the count item 2701 and “two-sided, 4in1” is selected as the reduction print setting item 2702, which cooperatively designate the display contents of the graphs 2791 and 2792.

The upper part 2791 of the display screen illustrated in FIG. 20 displays counting contents corresponding to designated items in the count item 2701 and the reduction print setting item 2702 for each month. The analysis processing unit 502 obtains counting results for each month by summing up the results in respective rows of the same “month of counting” column 1202 in the summary table illustrated in FIG. 9. A counting result 2721 indicates the actual CO2 emission amount for use of sheets during the month of June 2010. A counting result 2722 indicates the CO2 emission amount corresponding to the actual power consumption during the month of June 2010. A counting result 2723 indicates the CO2 emission amount for use of sheets during the month of June 2010 in the case of changing the reduction print setting. A counting result 2724 represents the CO2 emission amount corresponding to the power consumption during the month of June 2010 in the case of changing the reduction print setting.

Further, it is feasible to designate the month of counting in the graph displayed in the lower part 2792 by selecting a bar of the graph displayed in the upper part 2791 with a mouse pointer or the like. For example, if a user selects one of the bars 2721, 2722, 2723, and 2724, the counting result during the month of June 2010, i.e., the month of counting corresponding to the selected bar graph, may be displayed in the lower part 2792. Further, it is useful to display a selection menu upon a selection by the mouse pointer to enable a user to select a desired type of the graph to be displayed in the lower part 2792. For example, the selection menu including items of “for each device” and “device map” may be displayed. In this case, if a user selects the item “for each device”, the graph illustrated in FIG. 17 may be displayed in the lower part 2792.

The lower part 2792 of the display screen illustrated in FIG. 20 illustrates an example of the device map graph that displays the setup location of each image forming apparatus on the map in association with the CO2 emission amount according to the present exemplary embodiment. The device map graph illustrated in FIG. 20 displays a circle graph of respective values stored in the summary table illustrated in FIG. 9 for each image forming apparatus. A map selection control 2703 enables a user to designate a name of a map to be displayed as a graph. According to the illustrated example, “Map A” is selected.

The device map graph displays circle graphs each indicating the power consumption amount and the CO2 emission amount of each image forming apparatus on a selected map image based on the positional information of each image forming apparatus registered to the selected map. The analysis processing unit 502 searches for an image forming apparatus whose map name in the column 2602 coincides with the selected map of the device map information table. The analysis processing unit 502 acquires the device ID in the column 2601 and its coordinate values in the column 2603 and 2604 and displays the image forming apparatus on the map.

The analysis processing unit 502 acquires counting results of the month of counting designated in the upper part 2791 of the display screen for each image forming apparatus to be displayed on the map from the summary table illustrated in FIG. 9, and displays circle graphs indicating the counting results. The size of each circle graph is drawn to reflect the magnitude of a target counting result (e.g., the power consumption amount, the CO2 emission amount, etc). Therefore, each user may intuitively recognize a device that has large values with respect to the power consumption amount and the CO2 emission amount. As illustrated in this example, it is useful to display an inclined map image. To this end, it is desired to determine the display position of each image forming apparatus by correspondingly converting the coordinate position of the image forming apparatus. Further, a three-dimensional display may be realized by displaying a circle graph on the upper side of the display position of a corresponding image forming apparatus. In the present exemplary embodiment, the image forming apparatus A (the device A) is displayed at a position 2715 on the map based on its positional information.

As an example method for displaying a circle graph, actual counting values of the CO2 emission amount 2711 for use of sheets and the CO2 emission amount 2712 corresponding to the power consumption may be displayed as one circle graph (i.e., an external circle). The counting values of the CO2 emission amount 2713 for use of sheets and the CO2 emission amount 2714 corresponding to the power consumption in the case of changing the reduction print setting may be displayed as another circle graph (i.e., an internal circle). When two circle graphs are coaxially displayed, it is easy to check a change in the emission amount based on a comparison between the counting values.

Embodiments of the present invention may also be realized by executing the following process. That is, a process in which a software (e.g., executable program or instructions) that realizes the functions of the above-described embodiments is supplied to the system or apparatus via a network or a recording medium of various types, and then a computer of the system or apparatus (or devices such as central processing unit (CPU) or microprocessor unit (MPU)) reads out and executes the program or instructions. In such a case, the article of manufacture having the recording or storage medium where the program/instructions is/are stored as well as the program are included in one embodiment of the present invention.

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., an information processing apparatus, a storage device, an image forming apparatus). In addition, the operations in the method transform the elements or parts from one state to another state. The transformation is particularized and focused on collecting job history information. The transformation provides a different function or use such as storing an emission amount of greenhouse effect gases, generating display data indicating the emission amount of the greenhouse effect gas, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-193849 filed Aug. 31, 2010, which is hereby incorporated by reference herein in its entirety.

What is claimed is:

1. An information processing apparatus having a storage device and configured to collect job history information recording a content of a plurality of jobs executed by an image forming apparatus, the information processing apparatus comprising:
a counting unit configured to count as a result a number of sheets output by the image forming apparatus with reference to the job history information;
a first storing unit configured to store an amount of power consumed by the image forming apparatus, including an amount of electric power consumed for execution of a job, which is obtained based on the job history information, in the storage device;
a second storing unit configured to store an emission amount of greenhouse effect gases that is obtained based on the number of sheets counted by the counting unit and an emission amount of greenhouse effect gases that is obtained based on the power consumption amount stored in the first storing unit in the storage device;
a generation unit configured to generate display data required to display a screen indicating the emission amount of the greenhouse effect gas that is obtained based on the number of sheets and the emission amount of the greenhouse effect gas that is obtained based on the power consumption amount which are stored by the second storing unit; and
an analysis unit configured to analyze the number of sheets that is output by the image forming apparatus if at least either one of an aggregate print setting and a two-sided print setting is applied to a job corresponding to a history included in the job history information,
wherein the generation unit is configured to generate the display data required to display the screen in such a way as to indicate the emission amount of the greenhouse effect gas that is obtained based on the number of sheets analyzed by the analysis unit.

2. The information processing apparatus according to claim 1, wherein if applying at least either one of the aggregate print setting and the two-sided print setting is designated via the screen displayed based on the display data, the analysis unit is configured to analyze the number of sheets that is output by the image forming apparatus based on the designation.

3. The information processing apparatus according to claim 1, wherein if an application rate in applying at least either one of the aggregate print setting and the two-sided print setting is designated via the screen displayed based on the display data, the analysis unit is configured to analyze the number of sheets that is output by the image forming apparatus based on the application rate.

4. The information processing apparatus according to claim 1, wherein
the amount of electric power consumed by the image forming apparatus includes the amount of electric power consumed for execution of the job, which is obtained based on a job processing time calculated based on the job history information, and
the analysis unit is configured to calculate a job processing time required if at least either one of the aggregate print setting and the two-sided print setting is applied to the job corresponding to the history included in the job history information, and is configured to analyze an electric power amount to be consumed after the setting is changed according to the calculated job processing time.

5. The information processing apparatus according to claim 4, wherein the generation unit is configured to generate the display data required to display the screen in such a way as to indicate an emission amount of the greenhouse effect gas that is obtained based on the amount of electric power consumed by the image forming apparatus, which includes the electric power amount analyzed by the analysis unit as the electric power amount to be consumed after the setting is changed.

6. The information processing apparatus according to claim 1, wherein the amount of electric power consumed by the image forming apparatus includes the amount of electric power consumed in a normal mode and in a power saving mode.

7. The information processing apparatus according to claim 1, wherein
the generation unit is configured to generate display data required to display a screen that designs a circle graph indicating an emission amount of greenhouse effect gases by each image forming apparatus in association with the image forming apparatus disposed on a device map, and
the circle graph has a size proportional to the emission amount and indicates a ratio of the emission amount of the greenhouse effect gas that is obtained based on the number of sheets to the emission amount of the greenhouse effect gas that is obtained based on the power consumption amount.

8. A method for an information processing apparatus having a storage device and configured to collect job history information recording a content of a plurality of jobs executed by an image forming apparatus, the method comprising:
counting as a result a number of sheets output by the image forming apparatus with reference to the job history information;
storing an amount of electric power consumed by the image forming apparatus, including an amount of electric power consumed for execution of a job which is obtained based on the job history information, in the storage device;
storing an emission amount of greenhouse effect gases that is obtained based on the counted number of sheets and an emission amount of greenhouse effect gases that is obtained based on the stored power consumption amount in the storage device;
generating display data required to display a screen indicating the emission amount of the greenhouse effect gas that is obtained based on the stored number of sheets and the emission amount of the greenhouse effect gas that is obtained based on the power consumption amount;
analyzing the number of sheets that is output by the image forming apparatus if at least either one of an aggregate print setting and a two-sided print setting is applied to a job corresponding to a history included in the job history information; and
generating the display data required to display the screen in such a way as to indicate the emission amount of the greenhouse effect gas that is obtained based on the analyzed number of sheets.

9. A computer readable storage medium storing a program that, when executed by a machine or a processor, causes the machine or processor to perform operations for an information processing apparatus having a storage device and being configured to collect job history information recording a content of a plurality of jobs executed by an image forming apparatus, the operations comprising:
counting as a result a number of sheets output by the image forming apparatus with reference to the job history information;
storing an amount of electric power consumed by the image forming apparatus, including an amount of electric power consumed for execution of a job which is obtained based on the job history information, in the storage device;
storing an emission amount of greenhouse effect gases that is obtained based on the counted number of sheets and an emission amount of greenhouse effect gases that is obtained based on the stored power consumption amount in the storage device;
generating display data required to display a screen indicating the emission amount of the greenhouse effect gas that is obtained based on the stored number of sheets and the emission amount of the greenhouse effect gas that is obtained based on the power consumption amount;
analyzing the number of sheets that is output by the image forming apparatus if at least either one of an aggregate print setting and a two-sided print setting is applied to a job corresponding to a history included in the job history information; and
generating the display data required to display the screen in such a way as to indicate the emission amount of the greenhouse effect gas that is obtained based on the analyzed number of sheets.
